(19) United States
(12) Patent Application Publication
(10) Pub. No.: US 2022/0254212 A1
(43) Pub. Date: Aug. 11, 2022

(54) SYSTEMS AND TECHNIQUES TO PROVIDE SMART ACCESS CAPABILITIES IN A SMART SYSTEM ENVIRONMENT

(71) Applicant: Latch, Inc., New York, NY (US)

(72) Inventors: Luke Andrew SCHOENFELDER, New York, NY (US); Michael Brian JONES, New York, NY (US); David SHAPIRO, Chicago, IL (US); Saayuj DHANAK, New York, NY (US)

(21) Appl. No.: 17/171,540

(22) Filed: Feb. 9, 2021

(51) Int. Cl. G07C 9/25; G07C 9/00; G06K 9/00

(52) U.S. Cl. CPC G07C 9/257; G07C 9/00904; G07C 9/00309; G06K 9/00369; G06K 9/00744

(57) ABSTRACT

Embodiments are generally directed to a system and techniques to grant or deny access to a space.

### BACKGROUND

Smart access control systems can implement smart access control readers, electronic door activating hardware, and a backend system that together can manage credentials and authorizations. The readers receive credentials from users (for example, via a mobile device) and determine whether that user is authorized to perform its desired action, e.g., be allowed access to a particular area. If it is determined that the user is authorized to perform its desired action, the access control reader or an associated access device can unlock the electronic door activating hardware.

Traditional access control systems lack the ability to integrate with other smart building and home devices. Smart devices can include, for example, devices that are capable of being controlled remotely through a networking protocol, such as, but not limited to Internet Protocol (IP), Bluetooth, Zigbee, or Z-wave. Furthermore, building management companies who install smart devices in common areas and restricted spaces within the building (e.g., an apartment or gym) must coordinate many different types of credentials across many different types of systems.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example system 100 in accordance with embodiments.

FIG. 2 illustrates an example system architecture 200 in accordance with embodiments.

FIG. 3 illustrates a smart lock 300 in accordance with embodiments.

FIG. 4 illustrates a smart intercom 400 in accordance with embodiments.

FIG. 5 illustrates a smart hub 500 in accordance with embodiments.

FIG. 6 illustrates an access reader 600 in accordance with embodiments.

FIG. 7 illustrates a smart building system 700 in accordance with embodiments.

FIG. 8 illustrates a routine 800 in accordance with embodiments.

FIG. 9 illustrates a routine 900 in accordance with embodiments.

FIG. 10 illustrates a routine 1000 in accordance with embodiments.

FIG. 11 illustrates a routine 1100 in accordance with embodiments.

FIG. 12A illustrates a routine 1200 in accordance with embodiments.

FIG. 12B illustrates a routine 1238 in accordance with embodiments.

FIG. 12C illustrates a routine 1240 in accordance with embodiments.

FIG. 13 illustrates a location 1300 in accordance with embodiments.

FIG. 14 illustrates location 1300 in accordance with embodiments.

FIG. 15 illustrates an example of a device 1560 in accordance with embodiments.

FIG. 16 illustrates a routine 1600 in accordance with embodiments.

FIG. 17 illustrates a routine 1700 in accordance with embodiments.

FIG. 18 illustrates a routine 1800 in accordance with embodiments.

FIG. 19 illustrates an example of a device architecture 1900 in accordance with embodiments.

FIG. 20 illustrates an example of a communication architecture 2000.

### DETAILED DESCRIPTION

Embodiments discussed herein may be generally directed to methods, techniques, and systems to provide smart building and home technology services. As will be discussed in more detail below, the systems discussed herein enable users to manage and control various aspects of a building, including access control capabilities and monitoring services. The systems may enable a user to grant access to one or more areas of a building, such as a lobby, a particular floor, an apartment, etc., via one or more devices. For example, a user may utilize a mobile device executing a mobile application (app) associated with the system to determine when a person is present, identify the person, and grant or deny access to a space. These features may be provided via the system, including one or more computing devices configured to operate with smart devices, such as smart access devices, smart locks, smart hubs, smart cameras, etc. The computing devices may be further configured and networked together to enable users to interact with the system via one or more monitor devices, such as a computer executing monitoring software or a mobile device executing the mobile app. The system may include local networks, e.g., networks within a building, and be coupled with networks outside of the building, e.g., the Internet, to enable users to interact with the system while they are in the building or remote from the building. In one example, the system is configured to detect the presence of a person, identify a person to notify a device associated with the person, and provide a notification to the person via the device. The user may further interact with the system, e.g., utilizing monitoring components, such as cameras and microphones to see and talk with the detected person and to control access control devices, e.g., enable the detected person to enter one or more protected spaces. These and other details will become more apparent in the following description.

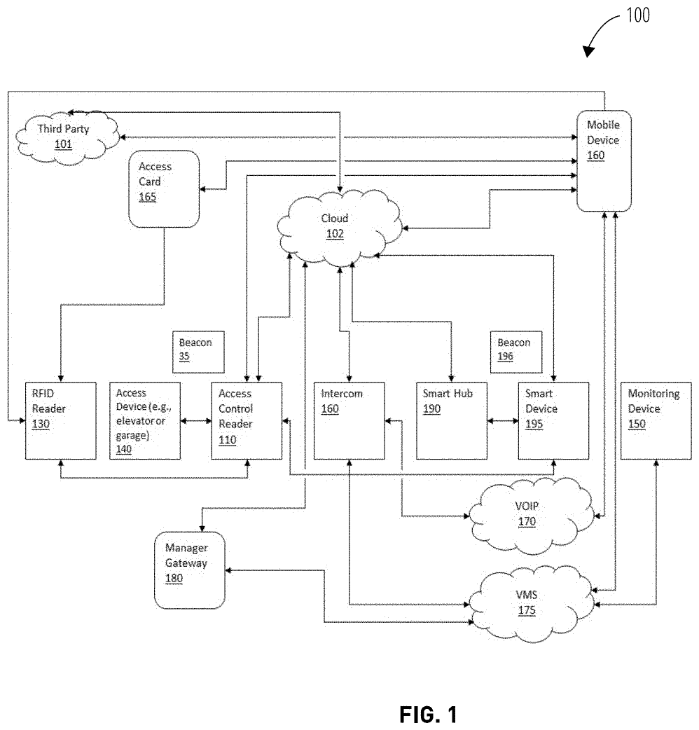

FIG. 1 is a diagram showing a smart building system 100 for a building in accordance with the embodiments discussed herein. The smart building system 100 can include one or more of a cloud-based computing system 102, at least one smart access control reader 110, at least one beacon 115, at least one access device 120, at least one NFC or RFID reader 130, at least one intercom 140, at least one monitoring device 150, at least one mobile device 161, at least one access card 165, at least one voice-over-IP (VOIP) network 170, at least one video management system (VMS) 175, at least one manager gateway access device 180, at least one smart hub 190, at least one smart device 195, a third-party cloud-based computing node 101, or at least one beacon 196. The system 100 may further include computing devices, such as one or more servers and/or computers to perform the operations discussed herein.

In some embodiments, the cloud-based computing system 102 includes one or more remote servers that can communicate with remote devices over a communications pathway including wired and/or wireless connections, such as the Internet, a WiFi network, a local area network (LAN), a cellular network, and so forth. Cloud-based computing nodes or servers 102 can store information about users of the smart building system, connect with a management gateway 180 to provide for management of the smart building system, and provide access and sharing privileges, e.g., via provisioning of credentials, for the usage of the smart building system. Management gateway 180 can be any type of computing device such as, but not limited to a server, a personal computer, a laptop computer, a smartphone, a tablet, etc. The cloud-based computing system 102 can further provide monitoring and/or alert functionalities, as described in more detail below.

In some embodiments, the smart building system 100 can include one or more access technologies that permit access to access points, such as doors or entryways, of the smart building system based on credentials that may be generated by the cloud-based computing system 102. For example, one or more smart access control readers 110 can include an integrated electronically actuated lock, which locks or unlocks upon receiving and authenticating a valid credential. In some embodiments, a separate remote card or signal reader, such as a near-field communication (NFC) or radio frequency identifier (RFID) reader 130, e.g., at a garage door or elevator, can provide information to an access control reader 110 to determine whether an entrant, e.g., into a garage or elevator, is authorized. In some embodiments, a separate access device 120 such as a control panel on an elevator or an automatic garage door opener can receive a credential from the NFC or RFID reader 130 and/or access control reader 110 and provide for access to other access points such as a garage door or elevator, respectively, upon authentication of the valid credential. In some embodiments, as described in more detail below, a beacon 115 can be associated with a smart access control reader 110, an access device, or both. As described in more detail below, the beacon 115 can contain information to assist with gaining access to the access point. In some embodiments, the beacon 115 can be an NFC tag, a quick response (QR) code, Bluetooth Low Energy (BLE) device, or another physical beacon that allows for encoding a link to tell the system what action to perform.

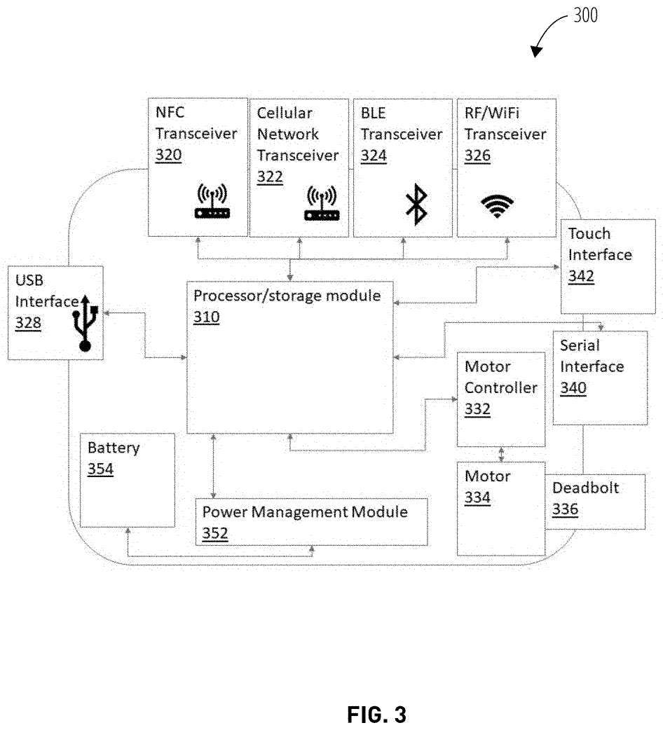

FIG. 3 is a block diagram of a smart lock 300, according to some embodiments. As shown in FIG. 3, the smart lock 300 can include a processor/storage module 310, an array of communications transceivers (e.g., NFC transceiver 320, cellular network transceiver 322, BLE transceiver 324, and/or RF/WiFi transceiver 326), a USB interface 328 (or other serial buses), a touch-sensitive interface 342, a serial interface 340, a locking assembly (e.g., including a motor controller 332, a motor 334, and deadbolt 336), a battery 354, and/or a power management module 352. The processor/storage module 310 can include instructions thereon that, when executed, cause it to perform the functions discussed throughout the present disclosure. For example, the processor/storage module 310 can be configured to receive or transmit information via one or more of NFC transceiver 320, cellular network transceiver 322, BLE transceiver 324, RF/WiFi transceiver 326, and/or USB interface 328. The processor/storage module 310 can be configured to instruct the motor controller 332 to control the motor 334 to unlock and lock the deadbolt 336. The processor/storage module 310 can be configured to identify the presence or absence of a person or object using information from a device coupled via an interface, such as serial interface 340. For example, the smart lock 300 may include and/or be linked with a device, such as a camera, a touch-sensitive interface, a proximity sensor, a radar sensor, and so forth, configured to detect the presence of the person. In some instances, the processor/storage module 310 is configured to process data based on the detected process and communicate data with other devices of the smart building system, such as the smart hub. The processor/storage module 310 can be configured to receive and process user inputs via a touch interface 342. The processor/storage module 310 can be configured to instruct power management module 352 to control the battery 354 and use thereof to power any of the elements in the smart lock 300.

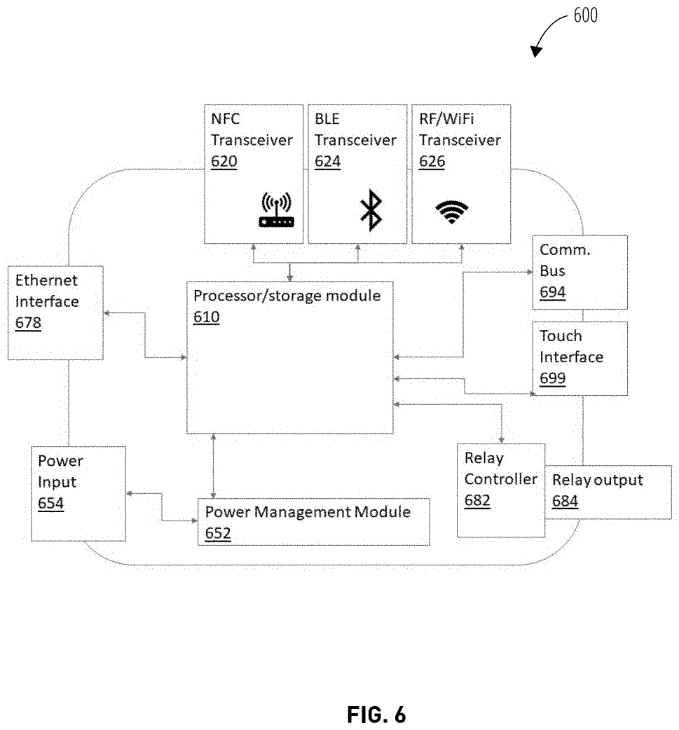

FIG. 6 is a block diagram of an access reader 600, according to some embodiments. As shown in FIG. 6, the smart access reader 600 can include a processor/storage module 610, an array of communications transceivers (e.g., NFC transceiver 620, BLE transceiver 624, and/or RF/WiFi transceiver 626), an ethernet interface 678, a communications bus 694, a relay output 684 controlled by a relay controller 682, touch interface 699, and/or a power input 654 regulated by power management module 652. The processor/storage module 610 can include instructions thereon that, when executed, cause it to perform the functions discussed throughout the present disclosure. For example, the processor/storage module 610 can be configured to receive or transmit information via one or more of NFC transceiver 620, BLE transceiver 624, RF/WiFi transceiver 626, and/or ethernet interface 678. The processor/storage module 610 can be configured to instruct relay controller 682 to control a relay output 684 to actuate a relay in another device. The processor/storage module 610 can be configured to receive or transmit information via communications bus 694, for example, instructions to instruct an elevator which floors can be accessed. The processor/storage module 610 can be configured to instruct power management module 652 to control and/or monitor the power input 654 and use thereof to power any of the elements in the smart access reader 600. In some embodiments, the smart access reader 600 can receive user input, such as a PIN or password, via a touch interface 699 in communication with the processor/storage module 610. The processor/storage module 610 can process the received input, for example, as described throughout the present disclosure.

With reference again to FIG. 1, in some embodiments, an intercom 140 can be installed at one or more access points. Intercom 140 can be any type of intercom, including but not limited to a virtual intercom or a smart intercom. Intercom 140 can monitor an access point, for example, by providing audio and/or video monitoring, and provide remote access to monitoring data for security, authentication, or other purposes.

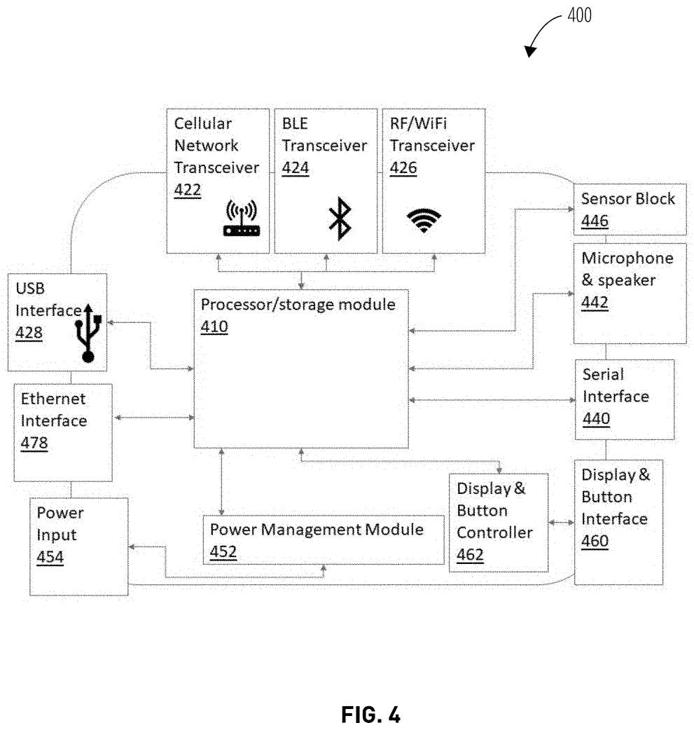

FIG. 4 is a block diagram of a smart intercom 400, according to some embodiments. As shown in FIG. 4, the smart intercom 400 can include a processor/storage module 410, an array of communications transceivers (e.g., cellular network transceiver 422, BLE transceiver 424, RF/WiFi transceiver 426), a USB interface 428, an ethernet interface 478, a power input 454 regulated by power management module 452, a sensor block 446, a microphone and speaker 442 (which may be separate elements), a serial interface 440, and/or a display and button doorbell interface 460 controllable by a display & button controller 462. The processor/storage module 410 can include instructions thereon that, when executed, cause it to perform the functions discussed throughout the present disclosure. For example, the processor/storage module 410 can be configured to receive or transmit information via one or more of cellular network transceiver 422, BLE transceiver 424, RF/WiFi transceiver 426, USB interface 428, and/or ethernet interface 478. The processor/storage module 410 can be configured to receive and process user input via the display and button interface 460 controllable by a display & button controller 462. The processor/storage module 410 can be configured to process and display information, images, or video via the display and button interface 460 controllable by a display & button controller 462. The processor/storage module 410 can be configured to receive input via the serial interface 440, such as image data from a camera. The processor/storage module 410 can be configured to receive audio input via the microphone of the microphone and speaker 442. The processor/storage module 410 can be configured to cause the speaker of the microphone and speaker 442 to emit an audio signal. The processor/storage module 410 can be configured to receive input from sensors of the sensor block 446. The processor/storage module 410 can be configured to instruct power management module 452 to control and/or monitor the power input 454 and use thereof to power any of the elements in the smart intercom 400.

With reference again to FIG. 1 in some embodiments, the smart building system can include one or more monitoring devices 150 that monitor an access point or area associated with the smart building system. Monitoring devices 150 can be any type of monitoring device such as, but not limited to a camera (for capturing the image or video data), a microphone (for capturing audio data), an infrared sensor, a motion sensor, a radar detector, water sensor (for leak detection), contact sensor (for sensing when doors or windows are opened, etc. As described in more detail throughout the present disclosure, monitoring device 150 can be used to compile additional data on access attempts. Furthermore, monitoring devices 150 implemented as radar detectors can be configured to monitor traffic patterns within a building. In embodiments, the monitoring devices 150 may be able to monitor where people are located within the building and determine when a person is trying to gain access to a space.

In some embodiments, a monitoring device 150 can be integrated with an access reader 600, and/or smart lock 300 with wireless capabilities, such as BLE capabilities. For example, an integral radar sensor can detect moving objects and check for correlations with BLE proximity unlocking attempts. If an object is detected with no correlating unlocking attempt, an event can be logged (as described in more detail below), indicating a potential unauthorized access attempt. In some embodiments, a radar detector can further identify obstructions in proximity to the access control reader that may interfere with a wireless signal to be emitted by the access reader 600, such as an RF or another wireless signal. The access reader 600 can then adjust the strength of the emitted wireless signal and/or notify an installer of the potential interference.

In some embodiments, a user can gain access to an access point and other elements in the smart building system by using one or more of a mobile device 161, an access card 165, a door code entered via a keypad. The mobile device 161 can receive one or more credentials from the cloud-based computing system 102 and provide the one or more credentials to an element in the smart building system in order to gain access. As described in more detail throughout the present disclosure, using the cloud-based computing system 102 to control credential generation for multiple components in the system can provide a number of benefits. For example, when implemented in an apartment building, an apartment building manager can seamlessly control access to common areas in the apartment building, manage access to apartments and smart devices contained therein, monitor access throughout the apartment building, including access to common or shared devices or areas for security purposes, monitor usage and problems with smart appliances, share management privileges or portions thereof with others using the smart building system (e.g., permit tenants to manage guest access), show available units to potential tenants without requiring a manager to be present, facilitate apartment turnover, facilitate maintenance or service provider access to particular areas and/or devices/appliances, etc. In addition, users of the smart building system, such as tenants, can use an application on their mobile device to access their apartment, common areas, and shared smart devices; permit guest or service provider access to devices or areas, control and manage smart home devices, monitor smart home devices and areas to which the user has access, etc.

In some embodiments, one or more of the access technologies can also have backward compatibility with credentials that were not generated by the cloud-based computing system 102. For example, the NFC or RFID reader 130 or smart access control reader 110 can be configured to accept a credential from an access card 165 that was previously used for a previous system. For example, when installing a smart building system, an existing access control device can be replaced with a smart access control device as described in more detail in U.S. Pat. No. 10,083,559 titled “Systems and methods for controlling access to physical space.” An access card 165 used with the previous access reader can then be used with the smart access controller.

As shown in FIG. 1, elements in the smart building system are communicating using various communication types in order to facilitate access to various areas and usage of various devices. For example, the mobile device 161 can receive credentials for a particular access point, such as NFC or RFID reader 130 or smart access control reader 110, from the cloud-based computing system 102 or by reading an RFID access card 165. The Mobile device 161 or access card 165 can provide a credential to NFC or RFID reader 130 to gain access to an access point. For example, NFC or RFID reader 130 can provide the credential to access control reader 110 using, for example, a Wiegand code, which can then unlock an integral smart lock or instruct another access device 120 to provide access via another Wiegand code. While the present disclosure discusses the use of Wiegand codes for many different applications, other protocols, such as but not limited to protocols covered by ISO/IEC 14443, ISO/IEC 15693, ISO/IEC 18000, mono-directional clock and data protocols, bidirectional Open Supervised Device Protocol (OSDP) (RS 485), RS 232, UART, Netherlands-based (NEN) standards, ISO/IEC 6523, ISO/IEC 15469, etc. can be used in place thereof.

In another example, a mobile device 161 may present a credential directly to an access control reader 110 using a wireless communication in accordance with Bluetooth, NFC, WiFi, cellular network communications, or another wireless connection type. The access control reader 110 may unlock the access point upon authenticating the valid credential. In some embodiments, the access control reader 110 instructs another access device 120, such as an elevator or garage door, to provide access to an access point, for example by transmitting a Wiegand code over a wired or wireless connection.

In another example, a user can provide access to an access point remotely. In some embodiments, the user can use a user mobile device 161 to request that access control reader 110 provide access, either by unlocking an integral electrically actuated lock or instructing an access device 120 to provide access. For example, a user can use an application or web terminal on the mobile device 161 to transmit to the cloud 102 a request to provide access. The request can be transmitted over a WiFi, cellular network, or other types of connection or combination thereof. The cloud 102 can then provide a valid credential to the access control reader 110, for example via a WiFi or cellular network connection or combination thereof, which will then provide access to the access point upon authenticating the valid credential. In some embodiments, the mobile device 161 can provide the credential directly to the access control reader 160 via a BLE, NFC, WiFi, cellular network, or other connection or a combination thereof to provide access to the access point.

The smart building system 100 can also facilitate requests for access, according to some embodiments. For example, a service provider or guest may arrive at the access point and request access via, for example, the intercom 140. Intercom 140 can collect and relay data, including video data, audio data, and user input relating to the request for access to the cloud-based computing system 102 via, for example, an ethernet, WiFi, cellular network, or other connection type or combination thereof for storage and/or transmission to the user mobile device 161. In some embodiments, the information can be relayed to a third party, such as a concierge, who can initiate a two-way video call with the visitor to welcome the visitor to the building or ask questions of the visitor to determine whether access should be granted. In some embodiments, the cloud-based computing system 102 and/or the intercom 140 can transmit at least some of the data to the user mobile device 161 to indicate that a guest has arrived at the building and is requesting access. In some embodiments, data is transmitted via a VoIP network 170 or VMS 175. In some embodiments, the user can transmit video, audio, or other data from the user mobile device 161 to the intercom 140 via similar connections, such as WiFi, cellular network, VoIP Network 170, VMS 175, or any other type of connection type or combination thereof, which can be displayed to the guest. Data can optionally be stored on the cloud-based computing system 102. The user can request access for a guest, via the user mobile device 161, either directly to the access control reader 110, via the intercom's 140 connection to the access control reader, or via the cloud-based computing system 102 to either the intercom or reader that the guest be provided access. In some embodiments, the user can request that the cloud-based computing system 102 provide a credential to the guest that can then be provided to the access control reader to gain access to the access point. In some embodiments, the requested credential can be transmitted to a mobile device of the guest. As described in more detail below, the guest credential can include additional credentials relating to other access points and devices in the building in order to enable the guest to fulfil the purpose of the visit. In some embodiments, data collected via an intercom 140 and/or user mobile device 161 can be provided to manager gateway 180, for example via VMS 175 or through the cloud-based computing system 102.

In some embodiments, the smart intercom 400 can be a virtual intercom. A virtual intercom may be code executable on a user's mobile device 161 and accessed by a user via an application, such as an applet or web browser. In one example, a mobile device 161 may capture a QR code or another indication or coded link (URL) and cause an application to navigate to a virtual intercom interface. In some embodiments, a guest may access a virtual intercom on a mobile application or website by entering in the address of the building. Once the guest's user mobile device 161 has accessed the virtual intercom interface, the guest can contact the recipient (e.g., an occupant of the building associated with the virtual intercom 140) via a plurality of methods, including, but not limited to, placing an IP call (e.g., using audio or video), sending a text message to the recipient, POTS call, or otherwise notifying the recipient that the guest is seeking access to the access point.

In some embodiments, monitoring device 150 in the smart building system can provide data to one or more of the cloud-based computing system 102, the manager gateway 180, and the user mobile device 161. As shown in FIG. 1A, in some embodiments this information can be provided via a connection such as VMS 175, Bluetooth, WiFi, or Zigbee, either directly to the manager gateway 180 or user mobile device 161, or to the cloud-based computing system 102. The user or manager may access data stored on the cloud-based computing system 102 in accordance with permissions. For example, if a monitoring device 150 is installed in a user's apartment, only the user may be able to gain access. The user can then have the option of permitting access to the manager for the data in the event of a suspected break-in or other emergency. In some embodiments the manager is the only entity permitted to access data in the cloud-based computing system 102 from a monitoring device 150 installed in a common area of the building via utilization of a unique password or code. In some embodiments, the cloud-based computing system 102 can be configured to give a tenant access to monitoring data under certain limited conditions, such as when the user has recently permitted guest access or when there is a suspected break-in.

In some embodiments, the smart building system can include one or more smart devices 195. Smart devices can include, but are not limited to, smart thermostats, smart outlets, smart home appliances, smart speakers, smart exercise equipment, smart leak detectors, smart shades, etc. Smart devices can interface with other elements in the smart building system, such as a smart hub 190, to receive commands or data, transmit data, receive information about user preferences, etc. Smart devices 195 can be associated with a particular area within the smart building system. For example, a credential generated by the cloud-based computing system 102 can be used to determine access to the smart devices 195, and/or to determine which users have permissions to control particular settings or attributes of the smart devices 195. In some embodiments, the access control reader 110, such as a smart door lock, can perform both the functions of the access control reader 110 and smart hub 190. In some embodiments, credentials are broken down into a sub-unit level. For example, in a shared dorm room, all residents may have access to a common smart thermostat, while only some may have access to smart lights in each respective dorm room.

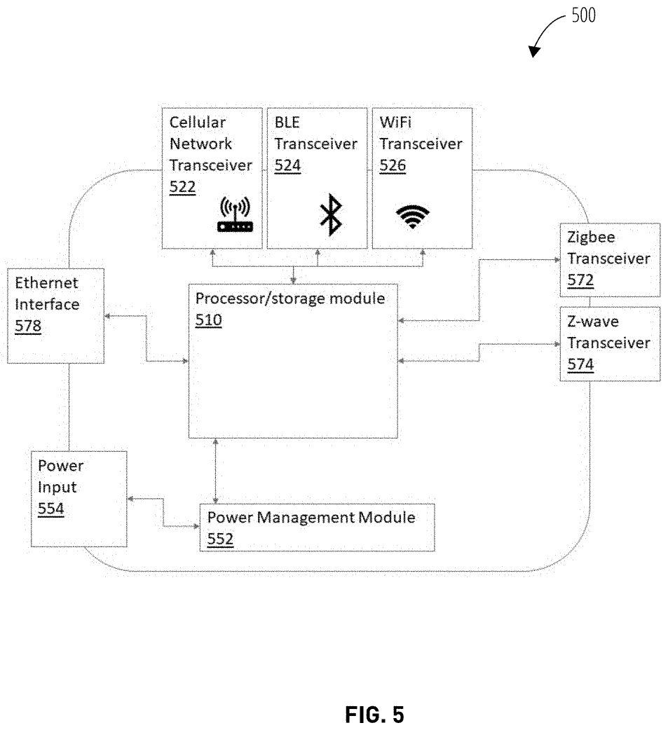

FIG. 5 is a block diagram of a smart hub 500, according to some embodiments. As shown in FIG. 5, the smart hub 500 can include a processor/storage module 510, an array of transceivers (e.g., cellular network transceiver 522, BLE transceiver 524, WiFi transceiver 526, Zigbee transceiver 572, Z-wave transceiver 574), an ethernet interface 578, and/or a power input 554 regulated by power management module 552. The processor/storage module 510 can include instructions thereon that, when executed, cause it to perform the functions discussed throughout the present disclosure. For example, the processor/storage module 510 can be configured to receive or transmit information via one of cellular network transceiver 522, BLE transceiver 524, RF/WiFi transceiver 526, USB interface 528, ethernet interface 578, Zigbee transceiver 572, and/or Z-wave transceiver 574. The processor/storage module 410 can be configured to instruct power management module 552 to control and/or monitor the power input 554 and use thereof to power any of the elements in the smart hub 500.

With reference again to FIG. 1, in some embodiments, the third-party cloud-based computing node 101 can be associated with a third party that sells, manufactures, or is otherwise associated with one or more particular smart devices 195 or access control readers 110 (e.g., smart locks). As described in more detail below, the third-party cloud-based computing node 101 can be involved in gaining access to or otherwise controlling smart devices 195. Third-party cloud-based computing node 101 can communicate with different elements in the smart building system such as, but not limited to the mobile device 161 and/or the cloud-based computing system 102. In some embodiments, third-party cloud-based computing node 101 communicates with the mobile device 161 via, for example, a wireless or wired internet connection or a cellular network. In some embodiments, the third-party cloud-based computing node 101 can communicate with the cloud-based computing system 102 via, for example, a wireless or wired internet connection or a cellular network. In some embodiments, the third-party cloud-based computing node 101 can communicate with an associated smart device 195 or access control reader 110 using a wireless or wired internet connection or a cellular network.

In some embodiments, particular areas, such as, but not limited to apartments, can be associated in the cloud-based computing system 102 with a smart hub 190 or access control reader 110. Associating Smart hubs with particular areas, such as apartments, can streamline smart building management, monitoring, and access functions. For example, when a user or manager requests, e.g., via user mobile device 161 or management gateway 180, that cloud-based computing system 102 provide to a user access credentials to an area, such as, but not limited to a guest, service provider, new tenant, the user or manager can also request cloud-based computing system 102 to coordinate credentialing for smart devices 195 associated with the area. The smart hub 190 or access control reader smart hub 110 can communicate wirelessly (for example, over Bluetooth, a wireless network, Zigbee, or a cellular network) with smart devices 195. In some embodiments, smart hub 190 or access control reader smart hub 110 can serve as a WiFi hotspot that provides local area WiFi networking for the area, e.g., apartment or common space, by broadcasting an internet connection received via an ethernet, WiFi, or cellular connection. In some embodiments, communications between the smart device 195 and the smart hub 190 or access control reader smart hub 110 can include, but are not limited to providing commands, providing software updates, providing settings changes, transmitting data, etc. Communications can be sent using a variety of formats or standards, including, but not limited to Zigbee or Bluetooth. The smart hub 190 or access control reader smart hub 110 can communicate with the cloud-based computing system 102 to receive or transmit communications, or directly with the user mobile device 161. In some embodiments, smart home devices 195 can communicate directly with cloud-based computing system 102, for example via a WiFi, a cellular network, or any other communication type. In some embodiments, a beacon 196 can be associated with a smart home device 195. As described in more detail below, the beacon 196 can contain information to assist with gaining access to or controlling the smart home device 195. In some embodiments, the beacon 196 can be a near field communication (NFC) tag, a QR code, BLE device, RFID tag, or other physical beacon, e.g., an image with encoded data or an audio beacon broadcasting a link via audible or ultrasonic code, that allows for encoding a link to tell the system what action to perform.

In some embodiments, when a manager or user requests that a guest receive temporary access to one or more access points in the building, because the cloud-based computing system 102 is responsible for all credentialing across the smart building system, the manager or user can more easily provide appropriate credentials for all access points and devices related to that guest's visit. For example, when a tenant requires service from a third party, such as a technician for a broken heating system, the tenant can request that the cloud-based computing system 102 provide credentials to the technician that allow for access to any access point leading up to the tenants apartment, the access point to the tenants apartment, and to change settings on the smart thermostat that controls the broken heating system all from one application on the user mobile device 161 of the technician, and without requiring the technician to seek separate credentials relating to each access point or smart device involved in the visit. Further, where time-limited credentials are used, each credential can be coordinated on the same time frame and in a way that works together, e.g., the credential for changing settings on the smart thermostat is only valid after use of a credential to enter the apartment, to increase security, ease of access, etc. In another example, when a tenant moves out of an apartment, a building manager can easily instruct cloud-based computing system 102 to transfer privileges to a new tenant, including privileges to access an access control reader 110 such as a smart lock, and all associated smart home devices including fixtures like smart appliances, smart thermostats, etc. In some embodiments, by using the same credentials across the entire system, building managers can more easily manage their buildings. In some embodiments, by using the same credentials across the entire system, users of the system can more easily share access to their properties and/or devices to guests, such as friends or those visiting for a short-stay accommodation. Users can gain, grant, and exercise access to multiple different locations using the same interface. Smart home control permissions can also automatically and/or temporarily transfer from a host to a guest in a short-stay accommodation, preserving the Guest's privacy and security without granting carte blanche access by the host.

In some embodiments, security measures are put in place whenever a credential is transmitted from one element to another. For example, transport of credentials over a public network can be conducted using a transport layer security (TLS), or equivalent protocol. In some embodiments, an exception can be made for BLE transfers (or Zigbee, Z-wave, NFC) executed for unlocking events. In some embodiments, all credentials stored on mobile devices and/or in other elements are stored in an encrypted state. When in use (e.g., when transmitted for validation) other encryption and security techniques can be used.

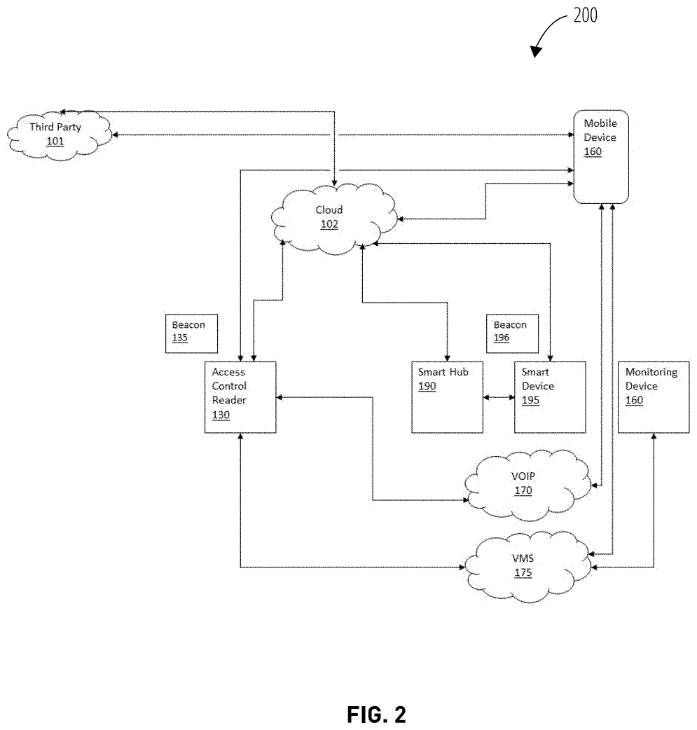

FIG. 2 is a diagram showing a system architecture 200 for an individual smart home system, according to some embodiments. As shown in FIG. 2, a smart home system can include similar elements to the smart building system and operate similarly to the operation described above. In some embodiments, the functionality of intercom 140 can be transferred to the access control reader 110, which can, for example, record video or audio of a guest at an access point and provide such data to a computing node of system 100 and/or the user mobile device 161 in order to determine whether to grant access to the guest and/or for security purposes. Access control reader 110 can still act as a smart home hub, thereby facilitating access to other connected devices in the individual smart home system and provisioning of access to guests and service providers, lessees, or new owners after sale of the home.

In some embodiments, both individual smart home systems, e.g., that shown in FIG. 2, and smart building systems, e.g., that shown in FIG. 1, can interface with the same computing node of system 100. Accordingly, users and managers can easily gain and transfer access to both access points and associated smart devices.

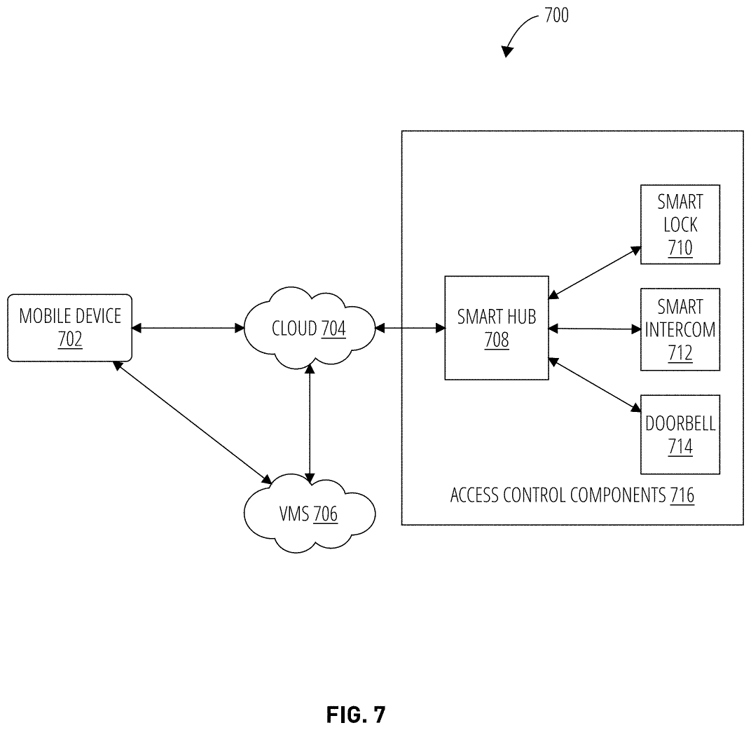

FIG. 7 illustrates an example of the smart building system 700 that may be configured to perform one or more operations discussed herein, including methods and systems for remote and secure access permission and monitoring. Embodiments enable users to selectively grant visitors access to a location without having to be physically present. For example, a user utilizes a mobile device to grant access to a space to a delivery person or friend. The smart building system 700 is also configured to automatically detect the presence of a person attempting to gain access to a space and notify a user or owner of the space of the detection. The smart building system 700 may provide a video stream or one or more images capturing the area where the person is detected and enable the user to grant or deny permission to the space remotely, via an application on the mobile device.

FIG. 7 illustrates a simplified example of the smart building system 700. Embodiments are not limited in this manner, and smart building system 700 may include additional components not illustrated. The smart building system 700 includes access control components 716 that may be configured to provide access to a space, such as a user's apartment, a room, an apartment common area, a building, a house, a storage location, a drop box, and so forth. FIG. 7 illustrates a single set of access control components 716; however, embodiments are not limited and this manner and the smart building system 700 may include many sets of access control systems for each point of entry for any number of spaces. For example, each apartment in an apartment building may have its own set of access control components and may be individually controlled by the owners/renters of the apartment.

The access control components 716 may include a number of components to enable a user to gain access to a space and to provide others access to the space, either locally while the user is in the space or remotely while the user is in a different location. The access control components 716 illustrated include a smart hub 708, a smart lock 710, smart intercom 712, and a doorbell 714. In other instances, the access control components 716 may include other components and devices, such as sensors, touch interfaces, cameras, smart intercoms, etc.

In embodiments, the access control components 716 may communicate with each other utilizing one or more wireless communication protocols, such as Bluetooth or Bluetooth Low Energy (BLE), Internet Protocol (IP) over WiFi, Zigbee, local area networking protocols, personal area network protocols, and so forth. In one configuration, the smart hub 708 may be communicatively coupled with each of the other components, the smart lock 710, the smart intercom 712, and the doorbell 714, and with other devices or systems of the smart building system 700. In this configuration, the smart hub 708 may operate as a go-between so that the other access control components 716 can communicate information and data with the other systems of the smart building system 700, such as systems and servers of a cloud system 704. However, in other instances, the access control components 716 may be configured to communicate directly with other systems and servers and not through the smart hub 708. In some instances, one or more of the access control components 716 may include hardware and software to operate as the smart hub 708. For example, smart hub 708 may be integrated and be part of the smart lock 710, eliminating the need for the separate smart hub 708. The smart lock 710 will provide the smart hub functionality in this configuration. Embodiments are not limited to this example, and other components of the access control components 716 may be configured with the hardware and software to provide smart hub functionality.

The smart building system 700 may also include a cloud system 704 and video management system (VMS) 706 coupled with the access control components 716. The cloud system 704 may be similar to or the same as cloud-based computing nodes or servers 102, and the video management system 706 may be the same as VMS 175, as illustrated and discussed in FIG. 1 and FIG. 2. The VMS 706 may include hardware and software to provide video management and monitoring services. For example, the VMS 706 may include one or more cameras placed within a space. The one or more cameras may be coupled with one or more servers of the VMS 706 that may receive data, such as image and video data, from the cameras to process and store in storage/memory. In embodiments, the smart building system 700 may also include and/or be coupled with one or more user devices, such as mobile device 702.

In embodiments, the cloud system 704 may include one or more backend servers to provide remote access services. These servers may include one or more services to process the data received by the access control components 716 and the video management system 706 to notify users of a detected person, enable users to view a video stream of the area around the detection on a remote device (mobile device), and enable users to permit or deny access to a space on the remote device. The cloud system 704 may also include cloud-based storage and store video or image data for users to access at a later point in time. Note that embodiments are not limited to utilizing a cloud-based architecture and cloud system 704 to perform the remote access services. In some instances, the smart building system 700 may also include one or more non-cloud-based backend servers on a dedicated private network, such as a local area network (LAN) or a wide area network (WAN).

In the embodiments, the smart building system 700 may be also be configured to communicate data between the access control components 716, the cloud system 704, the VMS 706, and other remote devices, such as mobile device 702. In FIG. 7, the mobile device 702 may be associated with the access control components 716. For example, the access control components 716 and mobile device 702 may be associated with the same user and/or user account. Thus, as will be discussed in more detail below, the user may receive information and data on the mobile device 702 related to and associated with the access control components 716, e.g., notifications of a person, video and images capturing the area around the access control components 716, and so forth via a mobile app or a web browser on the mobile device. The smart building system 700 is also configured to enable a user to interact and control the access control components 716 via the mobile device 702, e.g., via the mobile device or through the web browser. A user of the mobile device 702 may permit or deny entry to their space via the mobile application or web browser, for example. In embodiments, the smart building system 700 is configured to enable a user of the mobile device 702 to control other systems, including the VMS 706. For example, a user may select a particular camera capturing an area around their door or interact with the camera itself, e.g., sending commands to tilt, pan, zoom, etc., the camera.

In embodiments, the smart building system 700 is configured to detect the presence of a person within an area of a space, provide a notification to a user associated with the space, provide video viewing capabilities to the user, and enable the user to permit or deny access to the space. The smart building system 700 may detect the presence of a person in the area utilizing a number of techniques. For example, a person may utilize the doorbell 714 or a button associated with an access point or door, the doorbell 714 or button may provide an indication of the button press to one or more other systems or servers of the smart building system 700, e.g., via communicating with smart hub 708 or directly with a server of the smart building system 700. Similarly, the smart building system 700 may detect the presence of the person when the person engages the smart intercom 712 or touches a touch interface incorporated as part of the smart lock 710 or as a standalone device. In some instances, other components, such a proximity sensor, a motion sensor, or a radar sensor, are configured to detect the presence of a person. The indication communicated to the smart building system 700 includes data, such as a device identifier, a timestamp, a user account identifier, or any other identifying data that may be used by the smart building system 700 to determine a space and a user or user account associated with the detection.

In some embodiments, the smart building system 700 may detect the presence of a person utilizing one or more cameras of the VMS 706. The smart building system 700 may receive a video stream(s) or feed(s) from the VMS 706 and apply video analysis techniques to detect people in spaces. For example, the smart building system 700 may analyze one or more images or video streams from the VMS 706 to detect the presence of the person within an area around the door or a space. The video analysis techniques may include object or person detection techniques, such as background subtraction, optical flow, and/or spatial-temporal filtering techniques to perform detection of the person. In some instances, the smart building system 700 may classify an object as a human using shape-based, texture-based, or motion-based features. The smart building system 700 may perform additional analysis and determine when the person is within a specified range (e.g., 2 feet (ft.), 1 ft., 6 inches (in.), etc.) of another object, such as the door or smart lock 710. The analysis may utilize object detection techniques to identify the other objects (door, smart lock, door handle, or another object) and use distance measuring techniques such as triangle similarity to determine a distance between the person and the other object(s) based on a known size of the other object(s).

In embodiments, the smart building system 700 may notify the user or person associated with the access control components 716 and the space that a person is trying to access. For example, the smart building system 700 may determine a user account associated with the detection and communicate a notification to a device, such as mobile device 702, associated with the user and/or user account. As mentioned, the smart building system 700 may determine the associated user account using an identifier and performing a lookup in a database or storage system. In some instances, the smart building system 700 may determine a user account associated with the detection by performing a video analysis technique. For example, the smart building system 700 may apply one or more video analysis techniques to determine a specific door or access point, e.g., via a room number on the door/access point, associated with the detection and then determine a user account based on the determined door or access point.

The smart building system 700 may notify a user by sending an indication to an application and/or the mobile device 702 associated with the user account. For example, the smart building system 700 may send a mobile notification, such as text message, short message service (SMS) message, a multimedia message service (MMS) message, a push message, In-App messages, rich communication service (RMS) message, and so forth to the mobile device 702 to indicate the detection of the person. In another example, the smart building system 700 may notify the user via an application programming interface (API) communication with an application on the mobile device 702. The API communication may be one or more RESTful API communications over Hypertext Transfer Protocol (HTTP) utilizing transmission control protocol/Internet protocol (TCP/IP) over WiFi or a cellular connection (3G/4G/5G). Embodiments are not limited to this example.

In some instances, a user may wish to see the person attempting to access the door or entry point. The smart building system 700 is configured to process a request to see the person and provide video or image data to the user via the user's mobile device 702. For example, the smart building system 700 determines if one or more cameras are capturing the area around the door or access point in response to detecting a person and provides one or more images and/or a video stream to the user's mobile device 702. The video may be sent directly from the camera to the mobile device 702 or from the camera to the cloud system 704, VMS system 706, or smart hub 708 and from the cloud system 704, VMS system 706, or smart hub 708 to the mobile device 702, as applicable. The smart building system 700 may determine the specific door or access by storing camera locations for each camera of the VMS 706 in a database or store structure and associating each camera with one or more identifiers of the access control components 716 and/or the door. The smart building system 700 may utilize an identifier of the component or door, the user account identifier, etc. to perform a lookup to determine a specific camera capturing the door associated with a specific component indicating the presence of the person.

The smart building system 700 may also determine the camera capturing the person in the area based on information received from the VMS 706, e.g., an identifier of the camera supplying the video stream on which was the person was detected. The smart building system 700 may use the information from the VMS 706 to perform a lookup to determine the information with respect to the door, e.g., an associated user account, an identifier of the door, identifiers of components associated with the door, etc.

In embodiments, the smart building system 700 may provide the mobile device 702 images or video captured by a camera associated with the detection. For example, the smart building system 700 may determine the camera associated with detection and provide images and video captured to the mobile device 702 via API communications. The mobile device 702 may receive the images or video, and the user may view the images or video via a graphical user interface (GUI) in an application on the mobile device 702. In some instances, the application may enable a user to select a specific camera to provide the data if two or more cameras are capturing the user's door or area around the detection, and the smart building system 700 may provide images or video from the selected camera.

In embodiments, the smart building system 700 may be configured to store the images or video in a storage location, such as a cloud-based storage location, in a local storage location, in storage of the VMS system, or locally on cameras. The images or videos may be archived and retrievable by a user. For example, the application on a mobile device 702 may be capable of accessing the stored images or video and presenting them to the user in the GUI. A user may be able to select among one or more images or video captures and play particular ones based on interfaces with the GUI. Embodiments are not limited in this manner.

The smart building system 700 may be configured to enable a user to control one or more of the access control components 716 to permit or deny access to the detected person. For example, the application on the mobile device 702 may present an option via the GUI to permit or deny access. The option may be presented in any number of ways. For example, the application may present an icon or selectable item in the GUI to enable the user of the mobile device to select permit or deny via touch-sensitive interface or button selection. The icon or item may be in the form of a selectable graphic presented in the GUI, for example. In another example, the application may enable a user to permit or deny in an audio format, e.g., spoken by the user, provide a biometric input, etc.

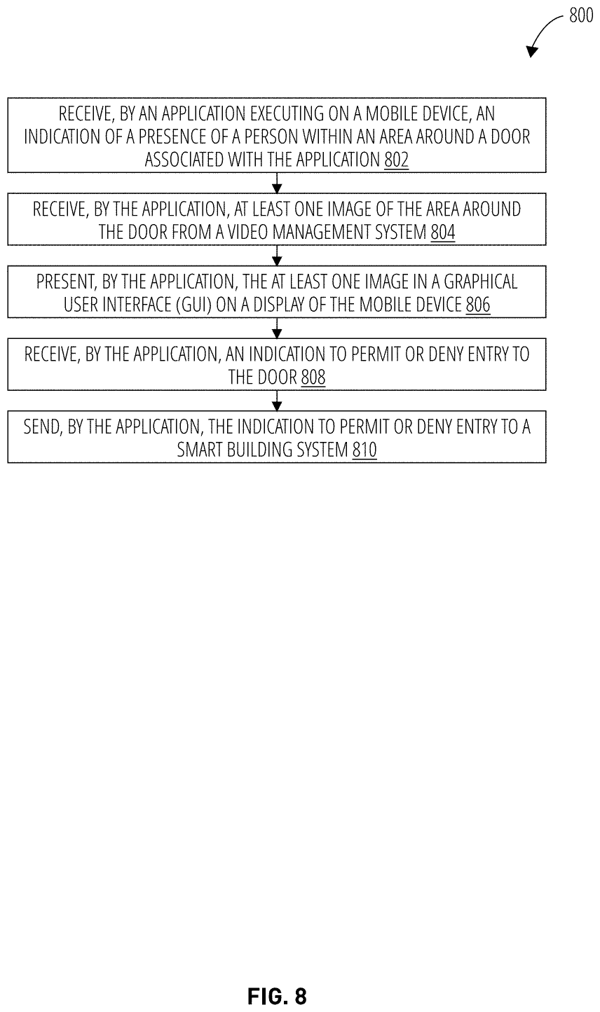

In embodiments, the mobile device 702 may communicate the selection to permit or deny to the smart building system 700, and the smart building system 700 may process the selection and cause the action selected, e.g., unlock or lock the door. For example, in response to receiving an indication to deny entry to the space, the smart building system 700 may send one or more signals or messages to one or more of the access control components 716 to cause the deadbolt in the smart lock 710 to remain in a locked state or move into a locked state. In response to receiving an indication to permit access, the smart building system 700 may send one or more signals to the smart lock to cause the deadbolt to unlock. The indication to lock or unlock the deadbolt may be sent directly to a smart access control component, e.g., the smart lock 710, or through the smart hub 708. Embodiments are not limited in this manner. Further, FIGS. 8-11 illustrate logic flow routines and additional details of operations that may be performed by the smart building system 700 to enable users to provide remote access to spaces.

FIG. 8 illustrates an example logic flow routine 800 that may be performed by one or more systems discussed herein. In one example, the steps of routine 800 may be performed by an application running on a computer device. In one example, the application may be a mobile app configured to execute on a mobile device, such as a mobile phone, a tablet, a personal digital assistant, etc. In another example, the application may be a web browser application configured to execute on a mobile device or another computing device, such as a personal computer, server, a laptop, etc. Embodiments are not limited in this manner.

In block 802, the routine 800 includes receiving an indication of a presence of a person. For example, an application may receive an indication from a smart building system indicating that a person is around a space or a door associated with the application or an account of the user of the mobile device. The indication may be received via one or more wired or wireless connection may be in a message format, such as a short message service (SMS) message or multimedia messaging service (MMS) message, an application notification, and/or one or more instructions to cause the performance of one or more operations on the mobile device, such as making the mobile device ring or vibrate.

In embodiments, the application may receive an indication from a server of the smart building system. The smart building system may include one or more servers that may receive and process information from components such as, one or more smart locks, smart hubs, and/or the video management system, and send the indication to the application based on a presence detection made by one of the components. The smart building system receives the information from the component(s), such as an identifier of the component making the detection (e.g., device identifier), an identifier of user account associate with the detecting component, an identifier of a user associated with the detecting component, and so forth. The component may make the detection in response to an action, such as pushing of a capacitive or mechanical button or doorbell, touching a smart lock or door handle, being within a defined distance of component (proximity detection), etc., and the detection may be made by one or more sensors, such as a button, a proximity sensor, a radar sense, a touch-sensitive sensor, a camera, etc. The application may receive the indication from the server and/or one or more of the components via an API communication or call, such as a RESTful API over Hypertext Transfer Protocol (HTTP) utilizing transmission control protocol/Internet protocol (TCP/IP) over WiFi or a cellular connection (3G/4G/5G). In embodiments, the application may receive the indication in a secure manner via Secure Sockets Layer (SSL)/Transport Layer Security (TLS). Embodiments are not limited in this manner.

In block 804, the routine 800 includes receiving at least one image associated with the detection. For example, the application may receive one or more still images or a video stream directly from the video management system or through another component or server of the smart building system. The area around the door may be defined by the viewing area of the camera capturing the at least one image. Further, the at least one image may be in any format, such as a Joint Photographic Experts Group (JPEG) format, Tagged Image File Format (TIFF) format, Graphics Interchange Format (GIF), bitmap (BMP) format, raw image format, and so forth. Other formats may include an Audio Video Interleave (AVI) format, Flash Video Format (FLV), Windows Media Video (WMV) format, Apple QuickTime Movie (MOV) format, Moving Pictures Expert Group 4 (MP4) format, and so forth.

In some instances, the application may enable a user of the mobile device to select a camera and to receive the one or more images from the selected camera. For example, the application may present one or more options to select cameras on the GUI. The application may receive and process a selection of one of the cameras and communicate the selection the smart building system. In response, the application may receive the one or more images from the specific camera the user selected. Thus, the user may have a number of options and viewing angles to identify the detected person.

In block 806, the routine 800 includes presenting at least one image in a graphical user interface (GUI) on a display. For example, the application may present at least one image in a GUI on the display of a mobile device or another computing device. The GUI may be presented in a standalone mobile application or in a window of a web browser. Embodiments are not limited in this manner.

In embodiments, the at least one image may be captured and presented with audio data including noises or audio captured by one or more microphones in and/or around the camera or the door. In some instances, the at least one image may be a real-time or near real-time video stream with two-communication enabled. The application may be configured to enable a user of the mobile device to send voice communications to the video management system that may be played through speakers near or around the door, e.g., within the viewing area. In embodiments, the application may include an icon or selection item for a user to select and then speak into a microphone of the mobile device. The application may process the audio data and send it to the video management system and/or smart building system to play through one or more speakers near the door. In this example, the application may be configured to enable the user to have a two-way conversation with the person near the door.

The application may also be configured to enable a user to control and manipulate the camera providing the one or more images. For example, the application may present camera controls in the GUI to enable the user to pan, zoom, tilt, move in different directions, and so forth. In some instances, the camera may be configured to perform control operations automatically. For example, the camera and the video management system may include object detection functionality to detect the person and configured to automatically move and focus on the person. Embodiments are not limited in this manner.

In block 808, the routine 800 includes receiving an indication to permit or deny entry to the door. In embodiments, the indication may be received by the application via a user input. For example, the application may present an icon or selectable item in the GUI to enable the user of the mobile device to permit or deny entry to the door. The icon or item may be in the form of a selectable graphic presented in the GUI. The application may receive the indication which may be based on a user selecting permit or deny via a touchscreen interface input or another button input. Embodiments are not limited in this manner, and the application may present the option to enable the user to select permit or deny access in other formats, e.g., spoken by the user (audio format), provide a biometric entry, etc.

In block 810, the routine 800 includes sending the indication to permit or deny entry to a smart building system. For example, the application may communicate with the server of the smart building system data, including the indication to permit or deny entry. In another example, the application may communicate the data directly to a component of the smart building system, such as the smart lock or smart hub. The data may be communicated via an API, e.g., a RESTful API over HTTP over TCP/IP. In some instances, the application may receive an indication indicating whether the selected action (permit or deny) was successful or unsuccessful. The application may also continue to present real-time images in the GUI such that the user of the mobile device can visually confirm that the person is permitted or denied access.

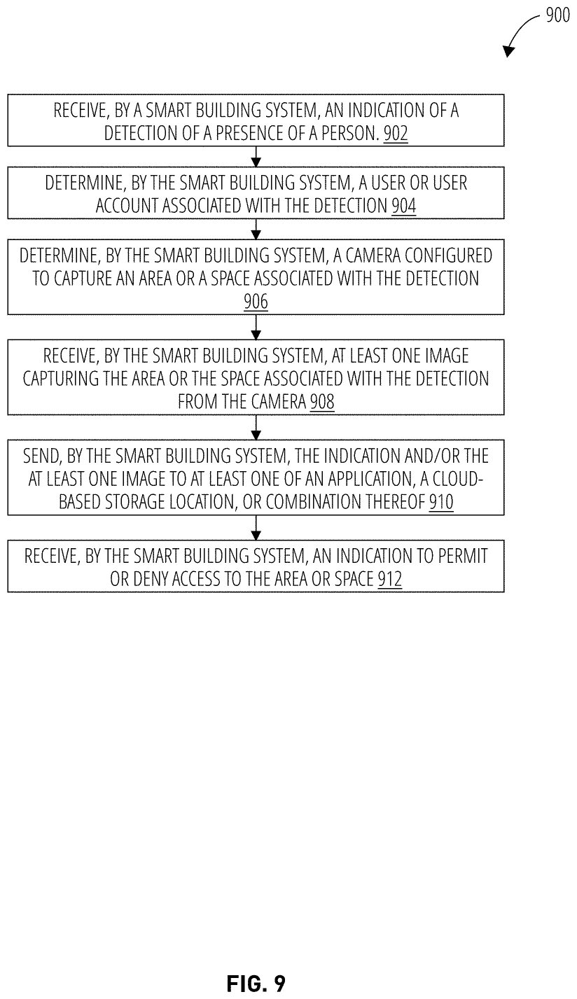

FIG. 9 illustrates an example logic flow routine 900 that may be performed by one or more systems discussed herein. In one example, the steps of routine 900 may be performed by one or more servers of a smart building system, which may be part of a cloud-based system and/or a local network. The one or more servers may execute instructions to perform the routine 900, for example. Embodiments are not limited in this manner.

In block 902, the routine 900 includes receiving an indication of a detection of a presence of a person within an area or a space. The smart building system may receive information or data from a component such as a smart lock, a smart hub, a button or doorbell, a camera, or a combination thereof, indicating the presence of a person at a particular door. In one example, the smart building system may receive data from a button when a user pushes the button or from a touch-sensitive interface when the user selects or touches the touch-sensitive interface. In another example, the smart building system may receive data from a component, such as the smart lock or smart hub, based on a detection made via a proximity sensor or radar sensor located in or around the door, the smart lock, a smart intercom, and so forth. As mentioned, the indication received from the component may include an identifier of the component, an identifier of a user associated with the component, an identifier of a user account associated with the user, etc.

In some instances, the smart building system may detect the presence of a person near a door by performing video analysis techniques. For example, the smart building system may analyze one or more images or video streams from the video management system to detect the presence of the person within the area around the door. The smart building system may utilize object or person detection techniques, such as background subtraction, optical flow, and/or spatial-temporal filtering techniques to perform the detection of a person. In some instances, the smart building system may classify an object as a human using shape-based, texture-based, or motion-based features. The smart building system may perform the analysis and determine when the person is within a specified range (e.g., 2 feet (ft.), one ft., 6 inches (in.), etc.) of another object, such as the door or smart lock. The analysis may also utilize object detection techniques to identify the other objects (door, smart lock, door handle, or another object) and use distance measuring techniques such as triangle similarity to determine a distance between the person and the other object(s) based on a known size of the other object(s). Embodiments are not in this manner.

In block 904, the routine 900 includes determining a user or user account associated with the detection. For example, the smart building system may perform a lookup in a database, or another storage structure based on the information received from a component and/or based on the analysis applied to data from the video management system. The information may include an identifier of the component and/or door that may be used to perform the lookup. The smart building system may also determine other information associated with the door/component, such as a mobile phone number to send an SMS or MMS message, or an account number to communicate with the application on the user's mobile device, a cloud-based storage location to store a copy of the one or more images detected by the video management system, and so forth.

In block 906, the routine 900 includes determining a camera capturing the area or the space associated with the detection. For example, the smart building system may store camera locations for each camera of the video management system associated with identifiers of the components and/or the door. Thus, the smart building system may utilize an identifier of the component or door, the user account identifier, etc. to perform a lookup to determine a specific camera capturing the door associated with a specific component indicating the presence of the person.

In some instances, and as previously discussed, the smart building system may receive data from the video management system and perform object detection analysis to determine a person is in the area around the door. In these instances, the smart building system may determine the camera capturing the person in the area based on information received from the video management system, e.g., an identifier of the camera. The smart building system may use the information from the video management system to perform a lookup to determine information with respect to the door, e.g., an associated user account, an identifier of the door, identifiers of components associated with the door, etc.

In block 908, routine 900 includes receiving at least one image capturing the area or the space. Specifically, the smart building system may receive images from the video management system. In some instances, the smart building system may request the images or video data from the video management system based on a lookup performed and detection made by a component of the system. In other instances, the video management system may provide the images or video data for each of the cameras, and the smart building system may analyze the data to detect the presence of the person, as previously discussed.

In block 910, the routine 900 includes sending the at least one image to at least one of an application, a cloud-based storage location, or combination thereof. Specifically, the smart building system may send the images to the application or cloud-based storage location based on the lookup and information determined based on the identifiers of the component(s), the user account, mobile device, etc. The smart building system may send the images as a link in a message to the mobile device, and the user may access the images via the link. In another example, the smart building system may send the images via an API communicating with an application on the user's mobile device.

In block 912, the routine 900 includes receiving an indication to permit or deny access to the door. For example, the smart building system may receive an indication from the mobile device via one more message and/or through an API. The indication may indicate to permit access through the door or to deny access through the door via a smart lock. In response to the indication denying access to the door, the smart building system may send one or more signals to the smart lock associated with the door to maintain the lock in the locked state. In response to receiving an indication to permit access, the smart building system may send one or more signals to the smart lock to cause the lock to unlock. Embodiments are not limited in this manner.

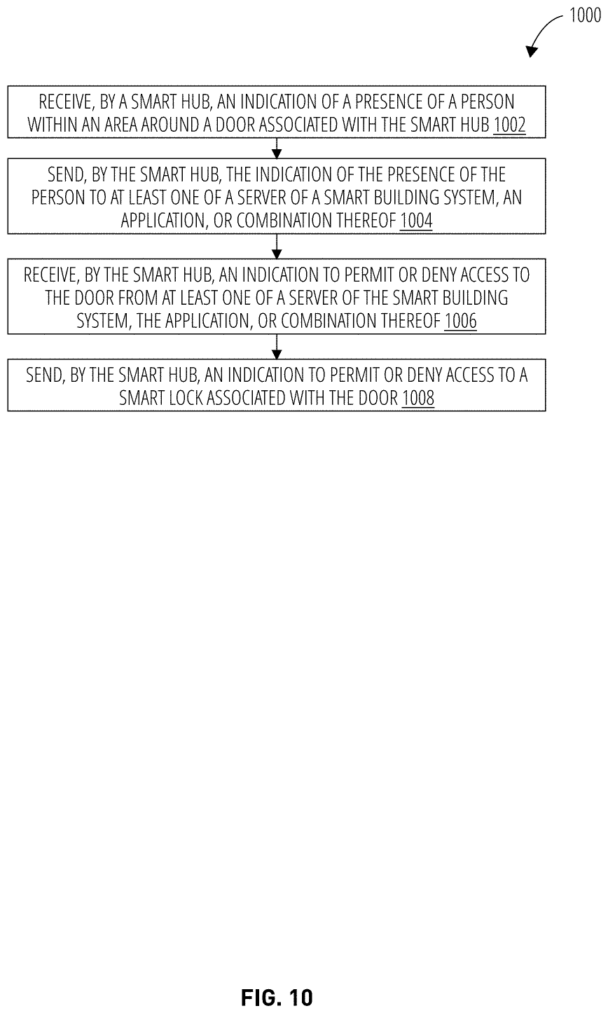

FIG. 10 illustrates an example logic flow routine 1000 that may be performed by a component of the smart building system, such as a smart hub. As previously discussed, the smart hub may include a processor, storage module, and other devices to perform the steps discussed herein. In some instances, the smart hub may communicate and perform one or more steps discussed herein with the server(s) of the smart building system or with an application on a mobile device directly, e.g., via the Internet and one or more wired and wireless connections. In some instances, the hub may be part of a smart access control device.

In block 1002, the routine 1000 includes receiving an indication of a presence of a person within an area around a door or an access point. For example, a smart hub may receive an indication of the presence of the person based on a detection made by another component, such as a button or doorbell detecting a button press, a touch-sensitive interface detecting a touch, a proximity sensor detecting a presence of a person, a radar sensor detecting a presence of a person, and so forth. The indication may include information, such as an identifier of the component performing the detection and a type of detection (button press, touch, proximity, etc.). The indication may be received via one or more wired and/or wireless communication may be made in accordance with one or more standards, such as Bluetooth, 802.11 (WiFi), Zigbee, etc.

In block 1004, the routine 1000 includes sending the indication of the presence of the person to at least one of a server of a smart building system, an application, or combination thereof. The indication may be provided by the smart hub and may include the identifier of the component detecting the presence, the type of detection, and information related to the smart hub, e.g., an identifier of the smart hub. The smart hub may communicate with the server and/or directly with an application on a mobile device or user device the indication via an API, and/or a mobile message. Embodiments are not limited in this manner.

In block 1006, the routine 1000 includes receiving an indication to permit or deny access to the door from at least one of the servers of the smart building system, the application, or combination thereof. The indication may be based on information received by the smart building system from a user via an application on a mobile device or directly from the application on the mobile device.

In block 1008, the routine 1000 includes sending the indication to permit or deny access to a smart lock associated with the door. For example, the smart hub may send one or more signals or data to the smart lock to cause the smart lock to unlock based on an indication to permit access to the door. Similarly, the smart hub may send one or more signals or data to the smart lock to cause the smart lock to remain in a locked state based on an indication to deny access to the door. In some instances, the smart hub may do nothing based on the indication to deny access, and the smart lock may remain in a locked state. Embodiments are not limited in this manner.

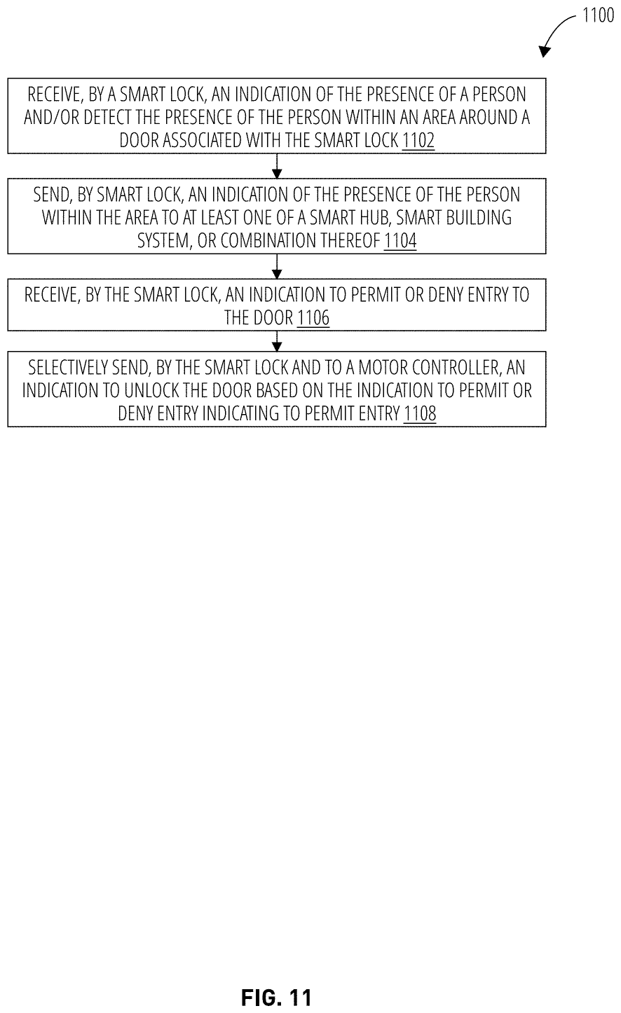

FIG. 11 illustrates an example logic flow routine 1100 that may be performed by a component of the smart building system, such as a smart lock. As previously discussed, the smart lock may include a processor, storage module, and other devices to perform the steps discussed herein.

In block 1102, the routine 1100 includes detecting the presence of a person within an area around a door associated with the smart lock. For example, the smart lock may include a touch interface and may detect the presence of the person based on a touch detection. In another example, the smart lock may include a button or doorbell on the housing of the smart lock, and the smart lock may detect a button press indicating the presence of a person. In other instances, the smart lock may be physically and/or communicatively coupled with a touch interface and/or a button located in standalone housing our in a different component, such as the smart intercom. The smart lock may make the detection based on information communicated by the touch interface, button, smart intercom, etc. The smart lock may include and/or be coupled with other devices such as a proximity sensor or radar sensor and may detect the presence of the person.

In block 1104, the routine 1100 includes sending an indication of the presence of the person to at least one of a smart hub, a server of a smart building system, or a combination thereof. The indication may be provided to the smart hub, the server, etc. in one or more wired and/or wireless communications in accordance with one or more standards, such as Bluetooth, WiFi, Zigbee, etc. The indication may include the identifier of the component detecting the presence and the type of detection.

In block 1106, the routine 1100 includes receiving, by the smart lock, an indication to permit or deny entry to the door. Further, and at block 1108, routine 1100 includes selectively sending, by the smart lock, an indication to unlock the door based on the indication to permit entry. For example, the smart lock may receive one or more signals or data from the smart hub and/or the smart building system to cause the smart lock to unlock based on an indication to permit access to the door. The one or more signals or data may cause the processor to send signals to the a controller, which in turn causes the controller to move the deadbolt into the unlocked position or otherwise unlock the door. Alternatively, the smart lock may selectively send an indication to lock the door based on the indication to deny entry. In response to receiving an indication to deny access or entry to the door, the smart lock processor may send one or more signals to the controller to cause the controller to move the deadbolt into the locked position or otherwise lock the door. In some instances, the deadbolt may already be in the locked position, and the processor may do nothing.

In some instances, the smart building system can monitor the delivery of packages and/or performance of services within the location. In an exemplary embodiment, a host can preemptively enable delivery couriers or service providers to enter the host's home, or a secure storage space associated with the host when necessary. The disclosed system and methods can eliminate the need for a host (or another person who can grant access) to be present when a visitor requires access to a location under the control and/or request of the host, for example, to deliver goods or provide services at the location.

According to some embodiments, the systems and methods disclosed herein can be implemented as part of a smart access platform, for example, the one described in U.S. Pat. No. 9,666,000 titled “METHODS AND SYSTEMS FOR ACCESS CONTROL AND AWARENESS MANAGEMENT,” the contents of which are incorporated herein by reference in their entirety. According to some embodiments, an access control management system can provide “awareness” information, e.g., information about visitors accessing or using particular locations. Technologies that provide awareness information can include, cameras, proximity beacons, motion sensors, WiFi sensors, infrared (IR) sensors, audio sensors, visual sensors, accelerometers, position sensors, and other sensors that can detect a presence of one or more visitors. These various technologies may be implemented into one or more of the components discussed herein, e.g., a smart access device, a smart intercom, a smart lock, a smart hub, etc. In embodiments, one or more visitors, such as a courier, can attempt to enter a location secured by a door. The door can have an access control device that can communicate, e.g., wirelessly, with a cloud service. The access control device can detect the presence and/or identify of one or more of the visitors and can send information to a cloud service, e.g., information about the identified visitors. The smart access platform can also provide proximity-based notifications. According to some embodiments, a smart access platform can include communication with other devices and computers at the location and/or in the cloud as described in more detail in U.S. Pat. No. 9,666,000.

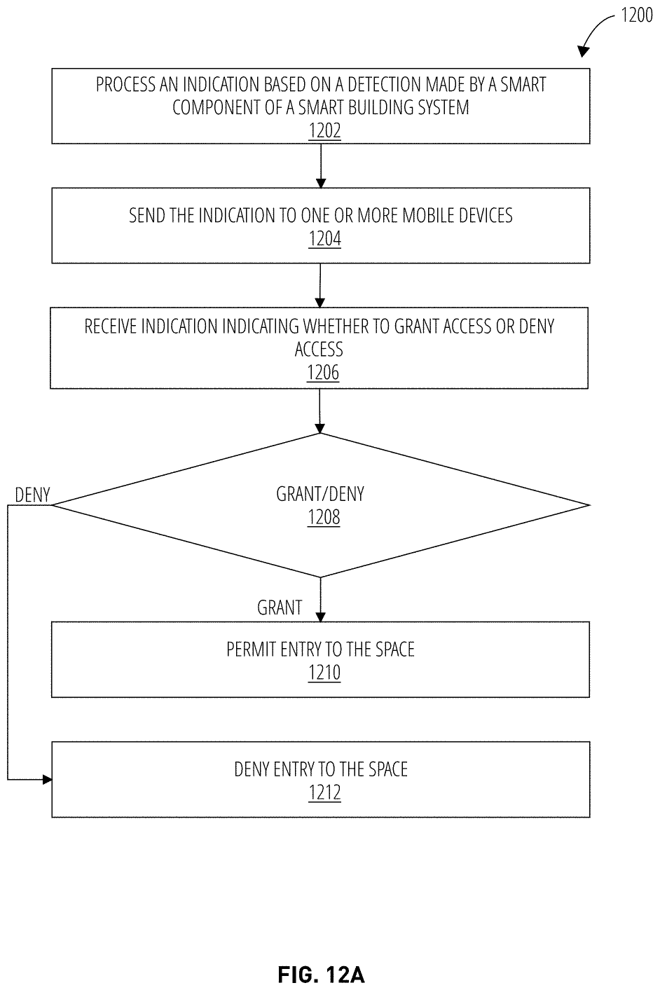

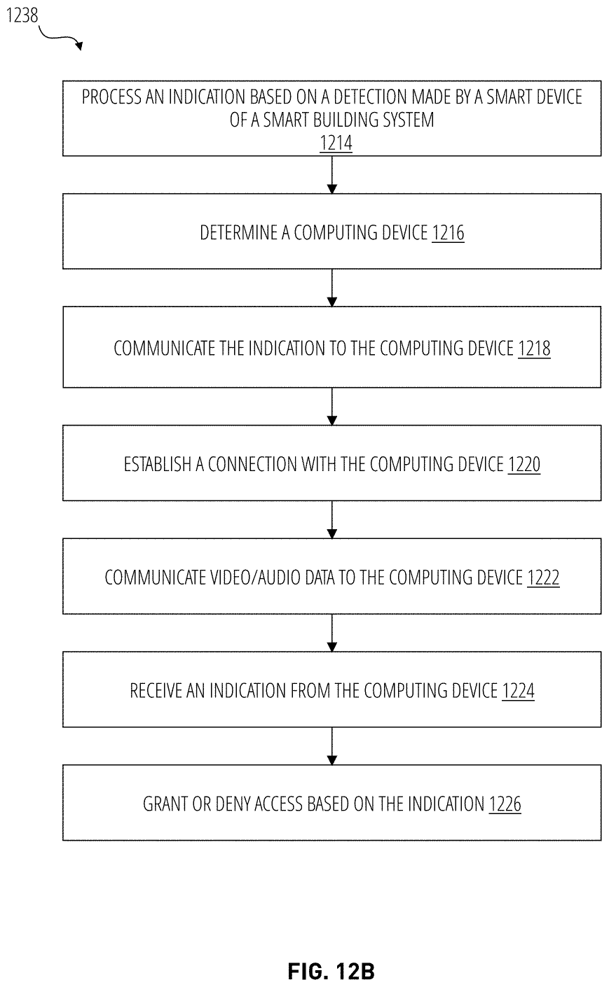

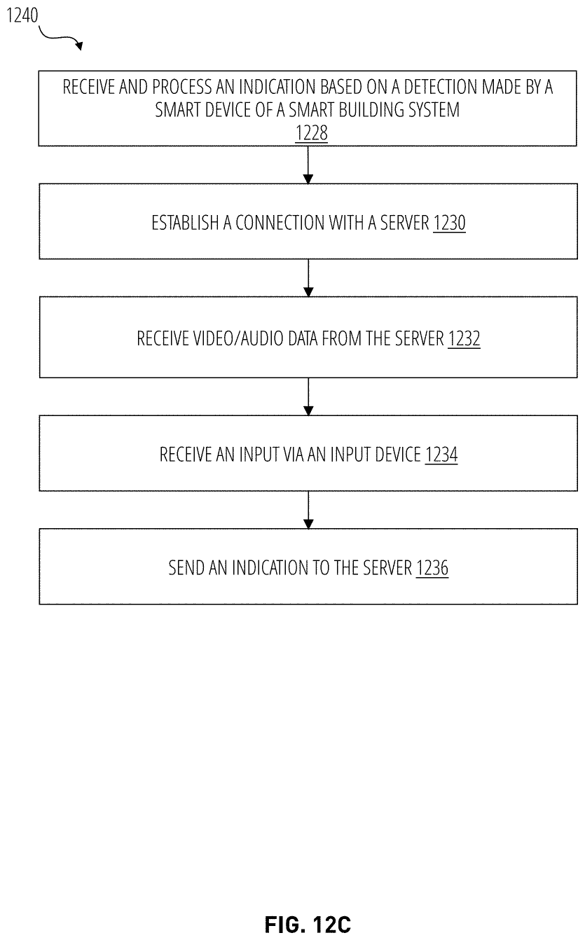

According to some embodiments, the system is configured to enable visitors, such as a delivery courier to deliver packages and gain access to a space. FIG. 12A illustrates one possible routine 1200 that may be performed by one or more systems discussed herein to process data based on a courier delivering a package. In embodiments, the system, such as system 100 of FIG. 1 and/or system 700 of FIG. 7, may include components outside of a space to enable a visitor to gain access to the space. For example, components, such as a smart intercom, one or more access control devices, cameras, microphones, and so forth may be located outside of the building. A visitor, such as a courier, may utilize the components to attempt to gain access to the building and/or a space. For example, a courier can arrive at a host's location with a package intended for a host or person associated with the location. The courier may interact with a component of the system 100, such as the smart intercom, by providing an input. At block 1202, the routine 1200 includes receiving and/or detecting an input indicating a package is being delivered. The system including the smart intercom may receive the input via input device, such as a button, a video camera, a microphone, etc., which may indicate the presence of a person. In some instances, the intercom may include a specific button or input device that may be used by the person to indicate that a package is for delivery, the specific button may be a package delivery button, a building management button, a security button, etc.

In some instances, the system may be configured to automatically detect the presence of a person. The system may also be configured to automatically detect the person as a courier. For example, the system may include a camera that may capture image and/or video data including the person and apply one or object and character recognition techniques. The object and character recognition techniques may be configured to detect characters on the person's clothing or a badge, for example. The system may compare the detected text to information in a datastore, such as a listing of known courier or company names, to determine if the person is a courier. If the person is wearing a uniform, the system may detect text, such as UPS®, FEDEX®, AMAZON®, etc., on the uniform. The system may be configured to detect symbols, such as logos that may be associated with couriers. In some instances, the courier may present a badge to the camera, and the character recognition techniques can be used to determine the specific courier to compare against a known list of couriers.

At block 1204 the routine 1200 includes communicating an indication of the detected input to one or more devices. For example, the smart intercom may be programmed such that when the specific button or input device is invoked, the intercom may send information to devices associated with one or more people or, e.g., a building manager or security personal, which may be preset or preconfigured. In some instances, the courier may select a button associated with a particular resident, e.g., the person receiving the package, and the smart intercom may send information to a device associated with the particular resident based on a configuration or setting. The smart intercom is not limited to a specific physical button and the input device may include other input devices, such as a touchscreen or touch interface.

In some embodiments, the system may determine a device to send the indication by performing a lookup in a database or data store. Specifically, the system may include a scanning device, such as a camera, configured to capture an image of the shipping label on a package and use the information on the label to lookup the recipient. In one example, the system may perform a character recognition technique on the shipping to detect information on the label, such as the recipient, an address, a phone number, etc. The system may compare the information on the shipping label to information stored in the database to determine a device associated with the agent or person to send the indication.

In embodiments, the system may communicate the information via one or more wired and/or wireless connections. In one example, the smart intercom may cause a message (SMS/MMS/etc.) to be sent to a message app on a device associated with the intended person. In another example, the intercom may communicate data to a smart building system mobile app on the device of the intended person, e.g., a mobile app notification, e.g., via an API message(s).

In embodiments, the agent or intended recipient may allow the courier to enter a location to deliver the package. At block 1206, the routine 1200 includes receiving an indication indicating whether to grant or deny access to the space. Further and at decision block 1208, the routine 1200 includes processing the indication and determining whether to grant access to a space for the package or not. For example, the agent or intended recipient may indicate via the mobile app of their device whether to permit or deny entry to the courier. The mobile app may provide a GUI display configured to receive the indication to permit or deny. The system may receive in the indication, e.g., via one or more communications, with the device and mobile app, and determine whether to permit or deny entry based on the agent or intended recipient's response. In some instances, the system may require the courier to enter one or more additional credentials, before enabling the person to enter the space. The credential may be a password or some identifying credential for the system to verify the courier.

At block 1210, the routine 1200 includes processing an indication to permit entry to the space and permitting entry. The system may permit entry via an access control device by sending one or more control signals or directives to the access control device to permit access. The space may be a specified location to put packages, e.g., a secure location, or a space associated with the intended recipient, e.g., a secure locker or the recipient's apartment. At block 1212, the routine 1200 includes processing an indication to deny access to the space and preventing the access to the space. In embodiments, the system may deny access to the space by doing nothing, running a routine to ensure an access control device remains locked, sending a notification to the courier (via a smart access component) that access was denied, etc. In some instances, the system may send a notification, or an email associated with the package delivery indicating that a package has been delivered and/or a delivery attempt was made but failed to the one or more devices.

In some instances, to permit access to the space, the system may communicate with a device associated with the courier or through the intercom. For example, the system may send a temporary digital credential or token to the device or through the intercom that may be used by the courier to gain access to the space. The courier may enter the token into one or more access control devices to pass through one or more doors to the space to place the package, for example.

FIG. 12B illustrates a second example routine 1238 that may be performed by a smart building system to process data based on a courier delivering a package or a person attempt to gain access to a space. At block 1214, the routine 1238 includes processing an indication based on a detection made by a smart device of a smart building system, the indication may indicate the presence of a person attempting to gain access to a space. For example, the system may include a smart intercom device configured to receive an input via input device, such as a button, a video camera, a microphone, etc., which may indicate the presence of a person. In some instances, the intercom may include a specific button or input device that may be used by the person to indicate that a package is for delivery, e.g., by performing a lookup in a data store. In other instances, the system may automatically detect the presence of the person based an objection detection performed on video data captured by a camera, as previously discussed.

At block 1216, the routine 1238 includes determining a computing device associated with the detection. Specifically, the system may determine a device to send an indication of the detection. The device may be operated by a building manager or a tenant, for example. In one example, a person may select via an input on the smart intercom device to select a particular person, and the system may determine a device associated with the particular person. In another example, the system may perform object and character recognition techniques to detect characters on a package or item, e.g., a person's name, address, phone number, etc., and the system may perform a look up based on the data detected to determine an associated device to communicate. In some instances, a default device may be configured to receive indications based on a presence a person. For example, a building manager's device may be configured as a default device to receive the indications.

At block 1218, the routine 1238 includes communicating an indication to the determined computing device. The system may communicate the indication via a message, such as SMS, MMS, etc., or via one or more API communications, as previously discussed.

At block 1220, the routine 1238 includes establishing a connection with the device. Specifically, the system may establish an audio and/or video connection with the device associated with the detection the person. In one example, the connection may be established between the smart intercom device or a standalone camera/microphone and the device though a mobile application. The connection enables the person attempt to gain access and the notified person to communicate with each other via audio and/or video communications at block 1222 of the routine 1238. The person receiving the indication may ask the courier to identify themselves, ask who the package is for, what their intended purpose is, etc. Embodiments are not limited in this manner.

At block 1224, the routine 1238 includes receiving an indication indicating whether to grant or deny access to the space. Further and at block 1226, the routine 1238 includes granting or denying access to the space based on the indication. For example, the system may determine the indication includes information to grant access to the space and send a control directive to an access control device to grant access. Alternatively, the system may determine the indication includes information to deny access to the space and send a control directive to an access control device to deny access, e.g., maintain a lock in a locked state.

FIG. 12C illustrates an example of a routine 1240 that may be performed by a computing device to process an indication that a person is attempting to gain access to a space. In embodiments, the computing device may be a mobile phone or a mobile device including memory and processing circuitry. The mobile device may include one or more applications, such a mobile app that may be configured to operate with a smart building system.

At block 1228, the routine 1240 includes receiving and processing an indication based on a detection made by a smart component or device of a smart building system. In one embodiment, a mobile app executing on a mobile device may receive the indication from a server or component of the smart build system. The indication may be communicated via an API communication, for example. In other instances, the indication may be communicated using other message types. The indication may be based on detecting the presence of a person by the smart building system. In one example, the smart building system may include a smart intercom device and the person may utilize the smart intercom device to generate the indication, e.g., via a button or interface selection. For example, the person may select, via an input device, a person associated with the mobile device. The system may determine the association between the person and the mobile device, e.g., by performing a look up in a data store or database and communicate the indication. The system may determine the device to which to communicate the indication automatically by other means, as previously discussed.

At block 1230, the routine 1240 includes establishing a connection between the mobile device and a server of the smart building system. The connection may be a secure connection and may be configured to communicate video and audio data between a component and/or a server of the smart building system and the app on the mobile device. For example, the app may include a graphical user interface (GUI) configured to display video data received from the server. Additionally, the app may also be configured to apply the audio data through a speaker of the mobile device. In embodiments, the video and audio data may be captured by one or more components of the smart building system and communicated to the mobile app on the mobile device at block 1232. In embodiments, the mobile device may also include one or more cameras and microphones configured to capture video and audio data. The data may be communicated by the mobile app back to the server of the smart building system for the smart building system to play on one or more of a display and a speaker of the smart building system.

At block 1234, the routine 1240 includes receiving an indication, via an input device, whether to admit or deny access to the space. For example, the mobile device may detect a button push or selection a graphical user interface icon to admit or deny access to the space and communicate an indication of the selection to the server. In another example, the selection may be made by via a user selecting via the GUI, such as a tapping an icon or word on a display of the mobile device. At block 1236, the routine 1240 includes sending the indication to the server of the smart building system. The smart building system may then grant or deny access based on the indication.

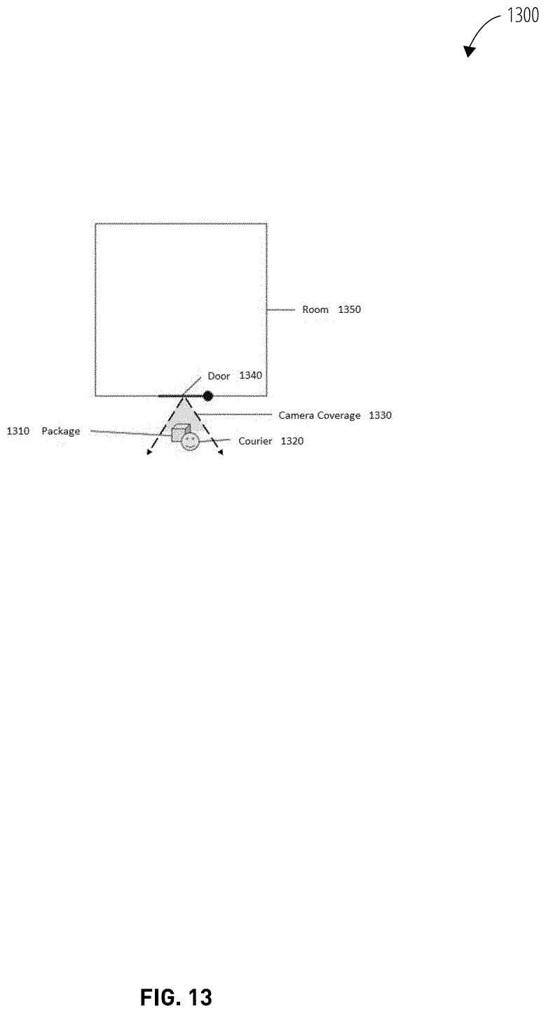

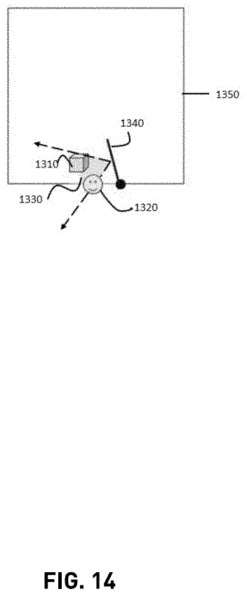

FIGS. 13 and 14 show a location or space with one or more components of system 100 and/or system 700, such as an access control device, an intercom, one or more cameras, one or more microphones, and so forth. As shown in FIG. 13, the location, for example, an apartment in a multi-apartment building, a single-family home, includes a door 1340 and at least one room 1350. The door 1340 can provide access to the room 1350. The room 1350 can be a free-standing structure or a room within a free-standing structure. The room 1350 can comprise a plurality of additional or sub-rooms included inside room 1350 with access provided via the door 1340 and other optional access ports such as other doors (not shown). As shown in FIG. 13, according to an embodiment, a visitor such as courier 1320 can arrive to drop-off a package 1310 at the location.

To facilitate secure access for the courier 1320, one or more access control devices can be installed on or near the door 1340. An access control device can include, but is not limited to cameras, proximity beacons, motion sensors, WiFi sensors, infrared (IR) sensors, audio sensors, visual sensors, accelerometers, position sensors, and other sensors that can detect the presence of one or more persons in the proximity of the access control device. According to an embodiment, the access control device can include a camera installed on or near the door 1340 with a camera coverage area 1330. When the courier 1320 arrives at the location, a trigger can set that can prompt the camera to begin recording. According to embodiments, the door 1340 can be unlocked in response to the presence of one or persons in the proximity of the access control device, for example, according to the exemplary methods disclosed herein, for example, the routines discussed in connection with FIGS. 3 and 4. In some embodiments, the courier may gain access to a space by communicating with an agent or a recipient of the package and the agent or recipient granting access, as discussed in routine 1200. As shown in FIG. 14, if the camera is mounted to the door 1340, the camera coverage area can shift with the motion of the door 1340, thereby allowing recording of at least part of the interior of the room 1350. As shown in FIG. 13, a camera can provide coverage, e.g., recording of the relevant area inside the room 1350, as the package 1310 and courier 1320 move into the room 1350, and the package 1310 is left in the room 1350. According to some embodiments, the package can be left in a predetermined drop-off zone that is covered by the camera. In some instances, a courier may include a device, such as a mobile device or handheld device configured to receive instructions and information from systems discussed herein. For example, the device may receive an indication that the courier is permitted to enter the space, e.g., via a messaging service or through an application message. In some instances, the device may receive additional information, such as instructions that may be read by the courier on where to place the package, e.g., at a drop off zone or location, a secure area associated with the recipient, the recipient's apartment, etc. In some instances, the space communicated to the courier may be an area inside the room 1350, which is within the field of view of the camera when the door 1340 is opened. According to some embodiments, the access control device can include a first camera and a second camera. The first camera can be provided outside the room 1350 to record images with a similar camera coverage area to the camera coverage area 1330 shown in FIG. 13. The second camera can be provided inside the room 1350 to record images with a similar camera coverage area to the camera coverage area 1330 shown in FIG. 14.

According to some embodiments, the visitor can also or alternatively have a personal device having at least one camera that is triggered in response to a visitor. According to some embodiments, the personal device can be triggered automatically in response to a triggering event, such as, but not limited to the visitor entering the camera coverage area 1330; detection of the visitor via a proximity sensor, Bluetooth, NFC, GPS, or any near field communication protocol; and/or the visitor interacting with the smart access device. Other triggering events are contemplated. According to some embodiments, the triggering can prompt the visitor to turn enable a camera of the personal device. Alternatively, the triggering can automatically enable a camera of the personal device.

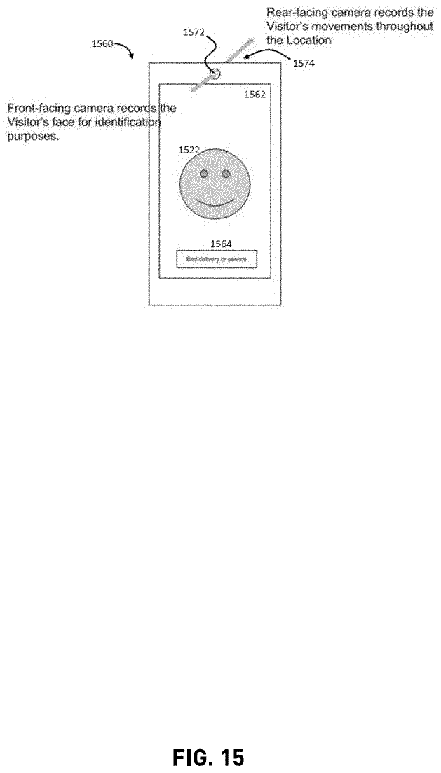

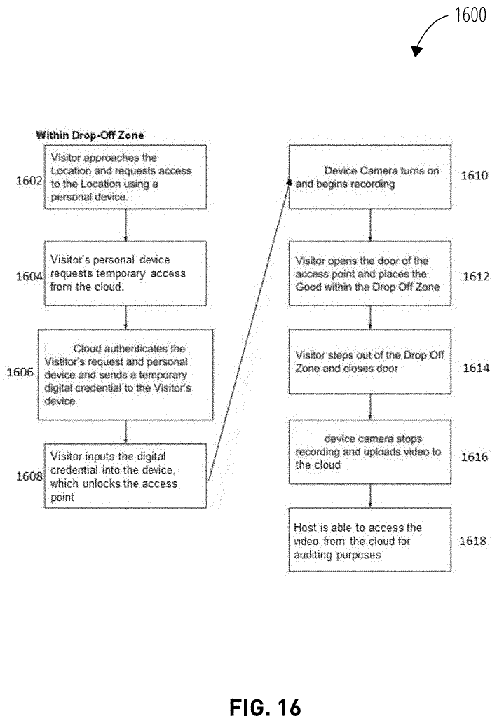

FIG. 15 shows a device 1560 that a visitor or courier may utilize to access a space with the systems discussed herein. In embodiments, the device 1560 may be a mobile device, a tablet, a smart phone, a personal digital assistant, etc. The device 1560 may include software, such as an operating system and applications. The applications may include message apps and an app associated with the systems discussed herein. The app may include instructions to perform operations discussed herein included those discussed with respect to routine 1600 of FIG. 16.

The device 1560 may include hardware including processing circuitry, memory, one or more interfaces, etc. to perform the operations discussed herein including recording and video capabilities. The device 1560 can beneficially be used, for example, using an app running on the device 1560, to record the delivery or performance of services in the event that delivery/performance instructions require the visitor to access the room 1250 beyond the drop-off zone (e.g., drop off a package or perform a service beyond the camera coverage area described in relation to FIGS. 13 and 14).

The device 1560 can have a front-facing camera 1572, and/or a rear facing-camera 1574 and a screen 1562. Device 1560 can have an app configured to connects with the systems discussed herein. The software can require the visitor to turn on at least one of the cameras 1572, 1574 on device 1560 during the duration of the delivery/performance of services, thus recording one or both of the movement of the visitor throughout the location as well as the visitor's face. According to some embodiments, the device 1560 can be holstered onto the visitor's body in order to allow the visitor to use both hands freely. As shown in FIG. 15, the visitor can see an image recorded by one of the cameras, such as the face 1522 of the visitor, on the screen 1562 of the device 1560. Other displayed information can include, for example, the time elapsed since visiting the location (i.e., since receiving the credential, since accessing the location, and/or since entering the location), an expiration timer on an access credential to the location, a delivery timer with an expected, actual, or required delivery time, or other types of relevant information to a delivery. As the visitor proceeds throughout the location, device 1560 can stream the visual imagery data from either or both of cameras 1572, 1574 to a cloud platform of the smart access platform. According to some embodiments, the streamed data can be stored in the cloud and/or streamed to the Host's personal device for viewing, or live streamed a personal device accessible by the host. According to some embodiments, the data can be streamed to a monitoring station where an authorized person can monitor the data, for example, as discussed in more detail in U.S. Pat. No. 10,515,495, the contents of which are incorporated in their entirety herein. According to some embodiments, the device 1560 can record and store video data locally, for example, using a local storage of the device 1560. If device 1560 streams to the cloud in real-time (for example, using wireless communication capabilities of the device 1560), then the host can be provided remotely with the video stream and can be able to watch the delivery or service in real-time from a remote location. According to some embodiments, the video data is stored locally and streamed to the cloud at a later time, for example using a batch process. After the video data is streamed to the cloud, the host can watch the delivery or service after the delivery or service has finished.

According to some embodiments, a delivery courier can be provided with instructions, for example, instructions presented to their device 1560, to leave a package in a particular space within the location beyond the drop-off zone. For example, during a grocery delivery, the delivery courier can be required to navigate through the location in order to reach the kitchen so as to place perishable goods in a refrigerator. Such delivery instructions would require the delivery courier to go beyond the drop-off zone. Similarly, service providers frequently have to access areas of a location such as kitchens, bathrooms, etc., to provide services. Accordingly, the system and methods described herein can provide for safe and secure access to the kitchen in order to ensure that the package, which can contain perishable goods, remains refrigerated without the host being at the location. In another example, delivery instructions can include directions for navigating the location or other information relevant to safe and efficient performance or delivery of the service or goods. Furthermore, the methods and systems disclosed herein do not necessitate placing cameras in every location where the visitor can gain access.

FIG. 16 is a routine 1600 of an exemplary method of dropping off a package within a drop-off zone, according to some embodiments. At step 1602, a visitor can approach a location for drop-off of a package and request access to the location. According to some embodiments, the request can be via a personal device, such as device 1560, when a visitor requests access using an application running on the personal device, or the request can be triggered automatically when the personal device is in proximity of the access control device, e.g., based on a WiFi or Bluetooth connection and/or connection attempt. Alternatively, the request can be issued using other devices, such as a device within the systems discussed herein. According to some embodiments, the request for access can take the form of a request for temporary access via a system, such as the cloud system, as shown in step 1604. At step 1606, the system can authenticate the visitor's request and the personal device. In some instances, the visitor can be verified by a camera a capturing image/video data of the visitor or an object associated with the visitor such as a badge, determining information from the captured image/video data, and comparing the information to verified information. For example, the system may perform an object or character recognition technique to detect letters or symbols on a uniform of the visitor and comparing the detected characters and/or symbols to verified information. If they match, the visitor may be verified. In another example, the visitor may be requested to present a badge to the camera and system may perform the object and/or characters recognition techniques on the image of the badge to determine information, such as the visitors name or likeness. The system may compare the information to the verified information. In another example, the system may request other biometrics from the visitor, provide a fingerprint or facial picture to perform biometric verification based known and/or verified biometrics. In another example, the system may verify the device 1560 of visitor, e.g., utilizing a device identification. A comparison can also be made to confirm that the particular personal device is authorized for the particular request or type of request at the particular time. In another, the visitor may be remotely by an agent or recipient of the package, as discussed in routine 1200.

After authenticating the visitor's request and personal device, a temporary digital credential can be sent to the visitor's personal device or the agent or recipient of the package may remotely initiate entry. This credential can take a number of forms, such as, but not limited to a door code, a Bluetooth authentication credential expressed via a Bluetooth-equipped personal device (e.g., a smartphone or a smartwatch), an NFC authentication credential, or any other forms of credentials. At step 1608 the visitor inputs the digital credential into an access point device, for example, by providing the door code, Bluetooth credential, or NFC credential, which unlocks the access point. In some instances, the door may be unlocked remotely by the agent or recipient via a command or directive enter in an app on a mobile device.

According to some embodiments, upon granting access to the location, a camera at the host's location can begin recording at step 1610. According to some embodiments, the camera is always recording or begins recording upon detection of the presence of a visitor. At step 1612 the visitor opens the door to the access point and places the package within the drop-off zone. As discussed above with reference to FIGS. 13 and 14, as the visitor opens the door, a camera mounted on the door can maintain the visitor in the camera's field of view. Accordingly, the visitor's actions can be recorded to confirm that the visitor did not take any unauthorized actions in the location.

At step 1614 the visitor steps out of the drop-off zone and closes the door. According to some embodiments, if the camera is attached to the door of the location, the camera can follow the user's actions as the visitor steps out of the drop-off zone and closes the door. According to some embodiments, upon a triggering event, such as, but not limited to, a timer, a location-based trigger for the visitor device, the visitor ending the recording, or any other appropriate triggering event, the camera can stop recording video and upload the recorded video to the cloud at step 1616. According to some embodiments, uploading can be accomplished in real time, rather than after the camera stops recording. Still according to other embodiments, the camera can continue recording until the presence of the visitor is no longer detected or can continue to record even in the absence of a user. Once the video data is uploaded to the cloud, the host of the location can access the video to remotely audit the delivery at step 1618. It should be appreciated that a similar method can be performed where the visitor is a service provider that visits a location to provide a service therein.

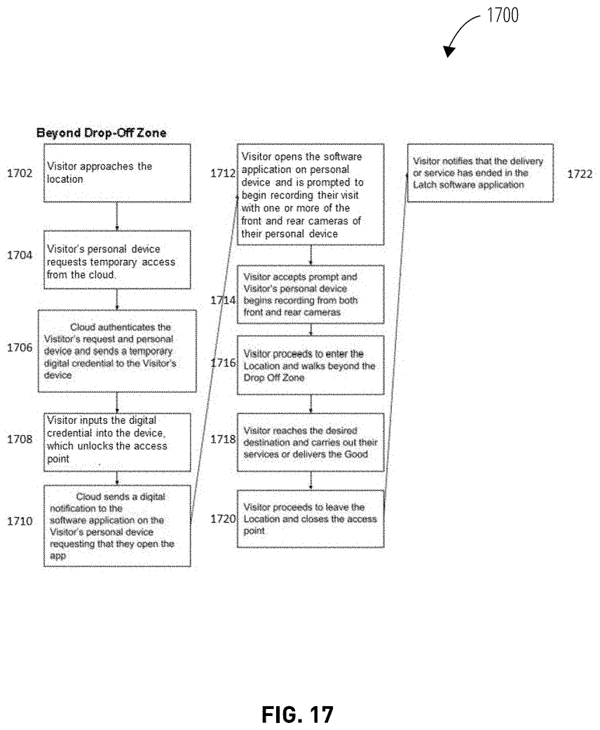

FIG. 17 is a routine 1700 of an exemplary method of dropping off a package beyond a drop-off zone, according to some embodiments. At step 1702, a visitor can approach a location for drop-off of a package. At step 1704, the user device requests access to the location. According to some embodiments, the request can be via a device of the visitor. However, the request can be using other devices, such as a device within a smart access platform. According to some embodiments, the request for access can take the form of a request for temporary access via one or more systems discussed herein. At step 1706, the system can authenticate the visitor's request and the device as discussed in more detail above and send a temporary digital credential to the visitor's device. This credential can take a number of forms, such as a door code, Bluetooth credential, or NFC credential. At step 1708 the visitor inputs the digital credential into a component of the system, such as an access point device or an intercom, which unlocks the access point.

At step 1710, the system can send a digital notification to a software application on the visitor's personal requesting that they open a video sharing application. According to some embodiments, the software application is the same application through which the visitor obtains the digital credential. According to some embodiments, the software application automatically begins recording and sharing video.

According to an embodiment, if the software application is not already open, at step 1712 the visitor can open the software application on the personal device and can be prompted in the application to begin recording their visit with one or more of the front and rear cameras of their personal device. At step 1714 the visitor can accept the prompt and the personal device begins recording from the front and/or rear cameras. According to some embodiments one or more of steps 1710-1714 can be performed before the steps 1706 and/or 1708 in order ensure that video is recording before granting access to the access point.

At step 1716, having been granted access to the access point, the visitor can proceed to enter the location and can walk beyond the drop-off zone. At step 1718, the visitor can reach the desired or predetermined destination and carry out the intended service or deliver the goods/package. The visitor can be required to stay in the field of view of one or more of the front or back cameras of the visitor's personal device.

At step 1720, the visitor can proceed to leave the location and close the access point. Then, at step 1722 the visitor can indicate that the delivery or service has ended. This can be accomplished, for example, by notifying the host via the software application on the visitor's personal device. According to some additional embodiments, completion of the delivery or service can be determined, for example, based on, for example, the expiration of a credential timer, input by the visitor (e.g., marking the delivery or service as completed), the geolocation of the visitor (e.g., once the visitor is outside of the location), an indication that the access point has been closed. The completion of the service or delivery can be determined based on the same triggering criteria that causes the video recording to stop. Accordingly, a delivery or service can be monitored at a host's location without requiring the physical presence of the host.

According to some embodiments, the system can also include an alarm function. For example, if the visitor is determined to have traveled outside or sufficiently outside of the camera coverage area 1230 (or to an unauthorized part of the location), the system can send a notification to the host in the form of an SMS, email, pushed alert, phone call, or other notification form. According to some embodiments, the unauthorized movement of the visitor can be determined based on a number of detection devices, such as, but not limited to, cameras, proximity sensors, GPS devices in the Visitor's personal device, etc. According to some embodiments, the host can use a combination of these detection devices to specify a critical path along which the visitor must travel. Deviation from this path can result in a notification. The critical path can be displayed to the visitor using, for example, the visitor's personal device. This display can take the form of an augmented reality interface.

In some instances, systems discussed herein are configured to perform multiple authentication operations prior to granting access to a space or location controlled by an access control device. For example, the system may be configured to receive a credential or token to access a location via an access control device. The system may be further configured to collect a biometric sample of the person attempting to gain access. The biometric sample may be compared to registered and authenticated samples. If the sample matches a registered sample associated with the credential or token, the system may grant access to the location via one or more access control devices. IF the sample does not match the registered sample, the system prevents the person from accessing the location.

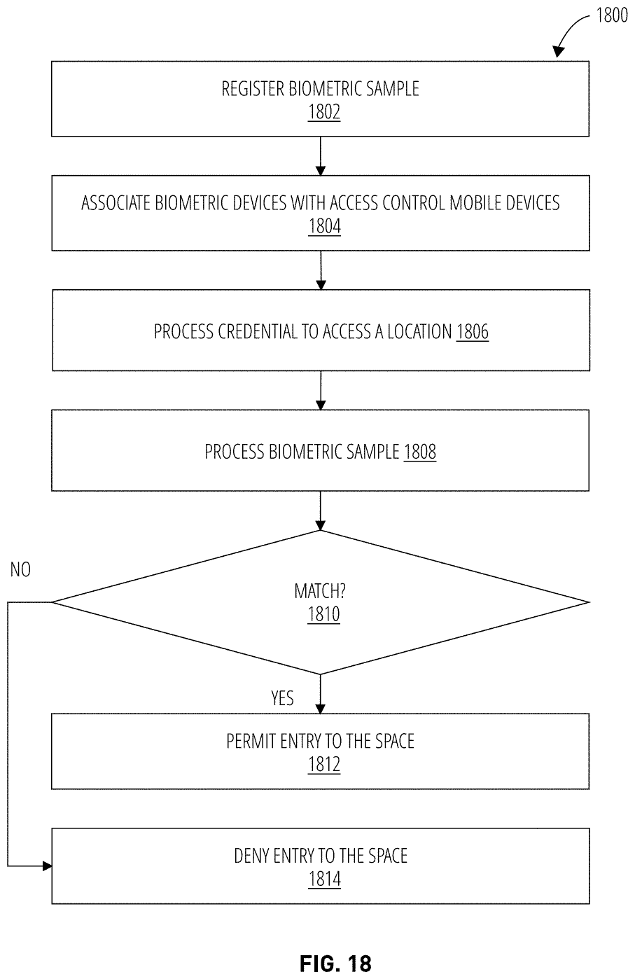

FIG. 18 illustrates an example routine 1800 that may be performed by a system to perform multiple authentication operations. At block 1802, the routine 1800 includes registering a biometric sample. For example, the system may be configured to conduct an enrollment process to collect and register authorized users, such as building administrators and tenants. The enrollment process may occur when the system is installed in a building and/or when a user needs to be added to the system, e.g., during a new tenant onloading process.

The system may be configured to collect any type of biometric sample, including but not limited to, a fingerprint sample, a speech sample, a face sample, a signature sample, a palm/hand sample, an iris sample, and so forth. Moreover, the system may be configured and operate with one or more biometric devices to collect the samples. In some embodiments, the smart locks may include a biometric device to collect a biometric sample, such as a fingerprint or a handprint. As discussed above, the system may include one or more cameras that may be used to take one or more images/videos of a person's face. These biometric devices may be integrated into another component of the system e.g., the smart lock, a smart intercom, etc., or a standalone biometric device.

In embodiments, the system may store the biometric samples in a data store or database that may be located on a server and/or in a cloud-based system. In some instances, the system may be configured to store the sample on one or more components of the system, e.g., in memory of a smart lock or the smart intercom.

At block 1804, the routine 1800 includes associating one or more biometric devices with one or more access control devices of the system. For example, the system may be configured such that biometric device is associated with the access control device it is near and/or in the same location. For example, a fingerprint reader may be associated with a smart lock that is next to it and intended to collect samples to gain access to a location controlled by the smart lock. In some embodiments, the system may run one or more operations to associate a plurality of biometric devices with particular access control devices. The association may be based on an identifier for each of the devices and stored in a data store or database.

At block 1806, the routine 1800 includes collecting and processing a credential to access a location via an access control device. The credential may be a token provided to the system to gain access to the location, as previously discussed.

At block 1808, the routine 1800 includes collecting and processing a biometric sample. For example, the system may prompt the user to provide biometric sample, e.g., via an indication on a display or through a speaker. In other instances, the system may be configured to collect the sample automatically, e.g., by a camera capturing images/video of the area.

At block 1810, the routine 1800 includes determining whether the collected biometric sample matches a verified biometric sample. In some instances, the system may compare the collected sample to every registered and verified sample stored in a data store. In other instances, the system may utilize an identifier, e.g., the token or credential, to retrieve a sample associated with token and compare the collected sample with the retrieved sample to determine they match. In other words, the credential may be associated with a particular biometric sample such that only the registered person may use the credential.

At block 1812, the routine 1800 includes permitting access to the location or space. For example, the system may send and/or execute a control directive to the access control component associated with the biometric sample and credential received, and the control directive may cause the device to open or unlock permitting access to a space. Alternatively, at block 1814, the routine 1800 includes denying access to a location or space. Specifically, the system may deny access when the collected sample does not match a verified sample and/or the credential is invalid. In some instances, the system may send one or more notifications or messages to devices associated with users of the system indicating that a person was denied access. For example, the system may send a message to a mobile device of the building administrator or a tenant of the building to another authority (police). The system may include information associated with the denial, a date/timestamp, a location or a specific access control device identifier, etc. In some instances, the system may include a biometric sample in the message, e.g., a picture of the person.

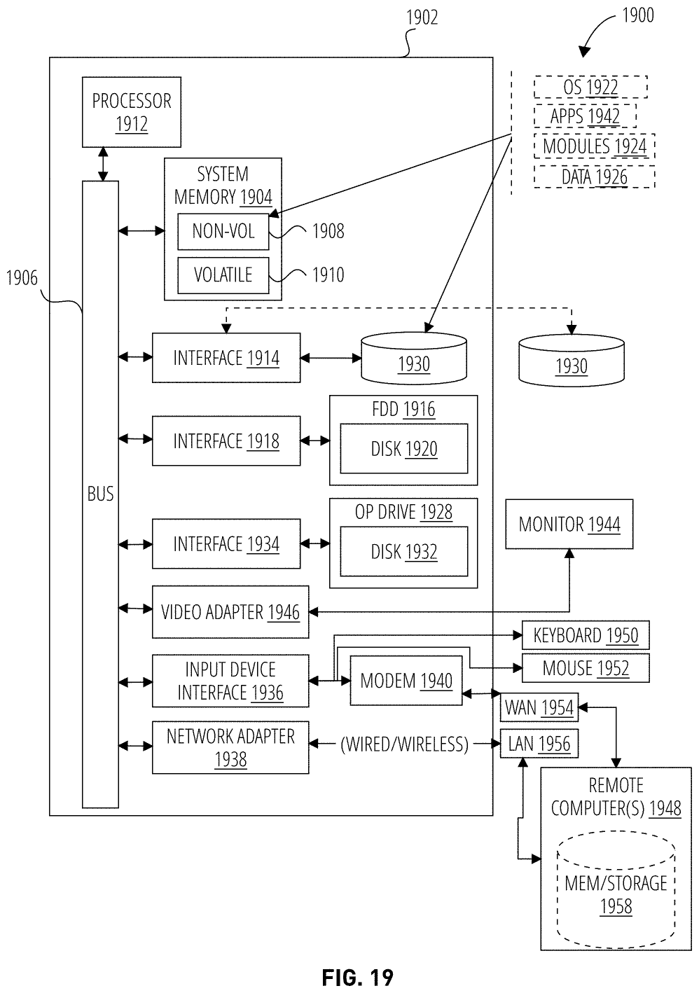

FIG. 19 illustrates an embodiment of an exemplary computer architecture 1900 suitable for implementing various embodiments as previously described. In one embodiment, the computer architecture 1900 may include or be implemented as part of systems discussed herein.

As used in this application, the terms “system” and “component” are intended to refer to a computer-related entity, either hardware, a combination of hardware and software, software, or software in execution, examples of which are provided by the exemplary computing computer architecture 1900. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 100 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 100.

As shown in FIG. 19, the computing architecture 100 includes a processor 1912, a system memory 1904 and a system bus 1906. The processor 1912 can be any of various commercially available processors.

The system bus 1906 provides an interface for system components including, but not limited to, the system memory 1904 to the processor 1912. The system bus 1906 can be any of several types of bus structure that may further interconnect to a memory bus (with or without a memory controller), a peripheral bus, and a local bus using any of a variety of commercially available bus architectures. Interface adapters may connect to the system bus 608 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1900 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1904 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 19, the system memory 1904 can include non-volatile 1908 and/or volatile 1910. A basic input/output system (BIOS) can be stored in the non-volatile 1908.

The computer 1902 may include various types of computer-readable storage media in the form of one or more lower speed memory units, including an internal (or external) hard disk drive 1930, a magnetic disk drive 1916 to read from or write to a removable magnetic disk 1920, and an optical disk drive 1928 to read from or write to a removable optical disk 1932 (e.g., a CD-ROM or DVD). The hard disk drive 1930, magnetic disk drive 1916 and optical disk drive 1928 can be connected to system bus 1906 the by an HDD interface 1914, and FDD interface 1918 and an optical disk drive interface 1934, respectively. The HDD interface 1914 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 1908, and volatile 1910, including an operating system 1922, one or more applications 1942, other program modules 1924, and program data 1926. In one embodiment, the one or more applications 1942, other program modules 1924, and program data 1926 can include, for example, the various applications and/or components of the systems discussed herein.

A user can enter commands and information into the computer 1902 through one or more wire/wireless input devices, for example, a keyboard 1950 and a pointing device, such as a mouse 1952. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 1912 through an input device interface 1936 that is coupled to the system bus 1906 but can be connected by other interfaces such as a parallel port, IEEE 1394 serial port, a game port, a USB port, an IR interface, and so forth.

A monitor 1944 or other type of display device is also connected to the system bus 1906 via an interface, such as a video adapter 1946. The monitor 1944 may be internal or external to the computer 1902. In addition to the monitor 1944, a computer typically includes other peripheral output devices, such as speakers, printers, and so forth.

The computer 1902 may operate in a networked environment using logical connections via wire and/or wireless communications to one or more remote computers, such as a remote computer(s) 1948. The remote computer(s) 1948 can be a workstation, a server computer, a router, a personal computer, portable computer, microprocessor-based entertainment appliance, a peer device or other common network node, and typically includes many or all the elements described relative to the computer 1902, although, for purposes of brevity, only a memory and/or storage device 1958 is illustrated. The logical connections depicted include wire/wireless connectivity to a local area network 1956 and/or larger networks, for example, a wide area network 1954. Such LAN and WAN networking environments are commonplace in offices and companies, and facilitate enterprise-wide computer networks, such as intranets, all of which may connect to a global communications network, for example, the Internet.

When used in a local area network 1956 networking environment, the computer 1902 is connected to the local area network 1956 through a wire and/or wireless communication network interface or network adapter 1938. The network adapter 1938 can facilitate wire and/or wireless communications to the local area network 1956, which may also include a wireless access point disposed thereon for communicating with the wireless functionality of the network adapter 1938.

When used in a wide area network 1954 networking environment, the computer 1902 can include a modem 1940, or is connected to a communications server on the wide area network 1954 or has other means for establishing communications over the wide area network 1954, such as by way of the Internet. The modem 1940, which can be internal or external and a wire and/or wireless device, connects to the system bus 1906 via the input device interface 1936. In a networked environment, program modules depicted relative to the computer 1902, or portions thereof, can be stored in the remote memory and/or storage device 1958. It will be appreciated that the network connections shown are exemplary and other means of establishing a communications link between the computers can be used.

The computer 1902 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously described may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

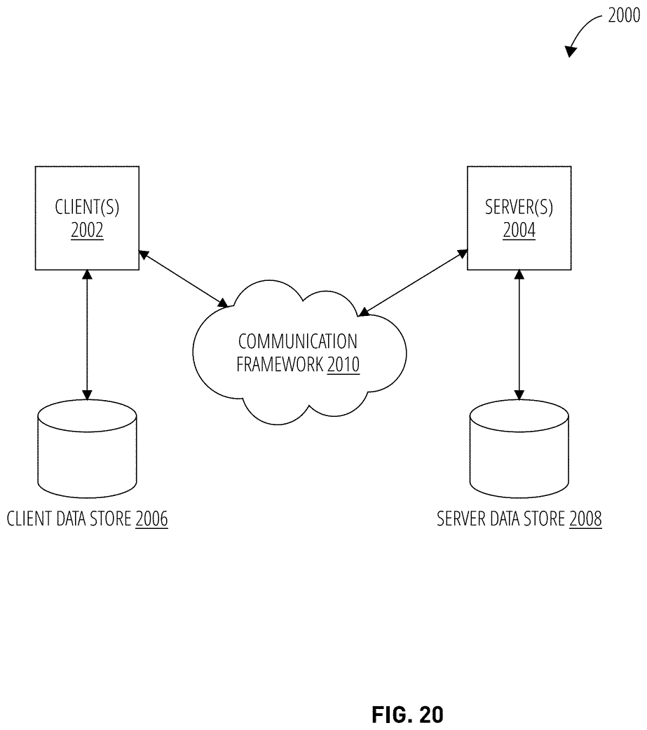

FIG. 20 is a block diagram depicting an exemplary communications architecture 2000 suitable for implementing various embodiments as previously described. The communications architecture 2000 includes various common communications elements, such as a transmitter, receiver, transceiver, radio, network interface, baseband processor, antenna, amplifiers, filters, power supplies, and so forth. The embodiments, however, are not limited to implementation by the communications architecture 2000, which may be consistent with systems discussed herein.

As shown in FIG. 20, the communications architecture 2000 includes one or more client(s) 2002 and server(s) 2004. The server(s) 2004 may implement one or more devices. The client(s) 2002 and the server(s) 2004 are operatively connected to one or more respective client data store 2006 and server data store 2008 that can be employed to store information local to the respective client(s) 2002 and server(s) 2004, such as cookies and/or associated contextual information.

The client(s) 2002 and the server(s) 2004 may communicate information between each other using a communication framework 2010. The communication framework 2010 may implement any well-known communications techniques and protocols. The communication framework 2010 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 2010 may implement various network interfaces arranged to accept, communicate, and connect to a communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.7a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by client(s) 2002 and the server(s) 2004. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

Although the disclosed subject matter has been described and illustrated in the foregoing exemplary embodiments, it is understood that the present invention has been made only by way of example, and that numerous changes in the details of implementation of the disclosed subject matter can be made without departing from the spirit and scope of the disclosed subject matter.

What is claimed is:

1. A computer-implemented method, comprising:
processing, by a smart building system, an indication based on a detection made by a smart device of the smart building system, the indication to indicate a presence of a person attempting to gain access to a space;
communicating, by the smart building system, the indication to one or more devices associated with the space;
receiving, by the smart building system, information from a device of the one or more device, the information to indicate whether to grant or deny the access to the space;
determining, by the smart building system, whether to grant or deny access to the space based on the information; and
in response to determining to grant the access to the space, causing, by the smart building system, a smart access control device to grant access to the space; or
in response to determining to deny access to the space, causing, by the smart building system, the smart access control device to deny access to the space.

2. The computer-implemented method of claim 1, comprising:
capturing, by the smart building system, video data, audio data, or combination thereof by the smart device; and
communicating, by the smart building system, the video data and/or audio data captured by the smart device to the device.

3. The computer-implemented method of claim 1, comprising:
receiving, by the smart building system, video data, audio data, or combination thereof from the device; and
presenting, by the smart building system, the video data on a display, the audio data through a speaker, or a combination thereof.

4. The computer-implemented method of claim 1, wherein the smart device comprises a smart intercom device comprising one or more input devices, a camera, and a microphone, and the method comprising:
detecting, by the smart intercom device, the presence of the person attempting to gain access to the space via one or more of the camera, the microphone, or a combination thereof;
generating, by the smart intercom, the indication based on the presence of the person detected; and
sending, by the smart intercom, the indication to a server of the smart building system.

5. The computer-implemented method of claim 4, comprising:
detecting, by the smart intercom device, an input by one of the one or more input devices to detect the presence of the person;
determining, by the smart building system, the device of the one or more devices to communicate the indication based on the input; and
communicating, by the smart building system, the indication to the device.

6. The computer-implemented method of claim 5, wherein the input is a selection of a button, the button associated with the device of the one or more devices.

7. The computer-implemented method of claim 5, wherein the input is a selection of an item in a graphical user interface (GUI) on a display, the item comprising one or more of a name, an address, a phone number of a combination thereof, and the item associated with the device of the one or more devices.

8. The computer-implemented method of claim 4, comprising:
applying, by the smart building system, object recognition to detect the presence of the person in video data captured by the camera of the smart intercom device;
applying, by the smart building system, another object recognition to determine text data in the video data, the text data comprising a name, a phone number, an address, or a combination thereof;
determining, by the smart building system, a device of the one or more devices to communicate the indication based on the text data; and
communicating, by the smart building system, the indication to the device.

9. The computer-implemented method of claim 1, comprising:
receiving, by the smart building system, video data from a camera of the smart building system;
applying, by the smart building system, object recognition to detect the presence of the person in video data;
applying, by the smart building system, object recognition to determine text data in the video data, the text data comprising a name, a phone number, an address, or a combination thereof;
determining, by the smart building system, a device of the one or more devices to communicate the indication based on the text data; and
communicating, by the smart building system, the indication to the device.

10. A computer-implemented system, comprising:
a plurality of smart devices; and
a computing device coupled with the plurality of smart devices, the computing device configured to:
receive and process an indication based on a detection made by a smart device of the plurality of smart devices, the indication to indicate a presence of a person attempting to gain access to a space;
determine a second computing device based on the indication;
communicate the indication to the second computing device;
establish a connection with the second computing device;
communicate video data, audio data, or a combination thereof to the second computing device, the video data, audio data, or the combination thereof associated with the detection;
receive a second indication from the second device, the second indication to indicate whether to grant or deny the access to the space;
grant or deny access to the space based on the second indication.

11. The system of claim 10, the computing device configured to:
in response to determining the second indication indicates to grant access to the space, cause a smart access control device to grant access to the space; or
in response to determining the second indication indicates to deny access to the space, prevent the smart access control device from granting access to the space.

12. The system of claim 10, the computing device configured to receive the video, the audio data, or the combination thereof from the smart device comprising a camera configured to capture the video data, and a microphone configured to capture the audio data.

13. The system of claim 10, the computing device configured to:
receive and process second video data, second audio data, or a combination thereof from the second computing device; and
present, the second video data on a display, the second audio data through a speaker, or a combination thereof.

14. The system of claim 10, wherein the smart device comprises a smart intercom device comprising one or more input devices, a camera, and a microphone, the smart intercom device configured to:
detect the presence of the person attempting to gain access to the space via the one or more input devices, the camera, the microphone, or a combination thereof;
generate the indication based on the presence of the person detected; and
send the indication to the second computing device.

15. The system of claim 14, the smart intercom device configured to:
detect an input by one of the one or more input devices to detect the presence of the person; and
the computing device configured to determine the second computing device of the one or more devices to communicate the indication based on the input;

16. The system of claim 15, wherein the input is a selection of a button, the button associated with the second device of one or more devices.

17. The system of claim 14, the computing device configured to:
apply object recognition to detect the presence of the person in video data captured by the camera of the smart intercom device;
apply another object recognition to determine text data in the video data, the text data comprising a name, a phone number, an address, or a combination thereof; and
determine the second device of the one or more devices to communicate the indication based on the text data.

18. The system of claim 10, comprising a camera, and the computing device to:
receive the video data from the camera;
apply object recognition to detect the presence of the person in the video data;
apply object recognition to determine text data in the video data, the text data comprising a name, a phone number, an address, or a combination thereof;
determine the second device of one or more devices to communicate the indication based on the text data.

19. A mobile device, comprising:
memory to store instructions of a mobile application; and
processing circuitry coupled with the memory, the process circuitry configured to process the instructions to:
receive and process an indication based on a detection made by a smart device of a smart building system, the indication to indicate a presence of a person attempting to gain access to a space;
establish a connection with a server of the smart building system;
receive video data, audio data, or a combination thereof from the server, the video data, audio data, or the combination thereof associated with the detection;
receive an input via an input device, the input comprising a second indication to indicate whether to grant or deny the access to the space; and
send the second indication to the server.

20. The mobile device of claim 19, comprising:
a camera coupled with the processing circuitry, the camera configured to capture second video data;
a microphone coupled with the processing circuitry, the microphone configured to capture second audio data; and
the processing circuitry to send the second video data, the second audio data, or a combination thereof to the server.
